(19) United States
(12) Patent Application Publication
(10) Pub. No.: US 2025/0113345 A1
(43) Pub. Date: Apr. 3, 2025

(54) METHOD AND APPARATUS FOR MEASURING A REFERENCE SIGNAL IN A WIRELESS COMMUNICATION SYSTEM

(71) Applicant: SAMSUNG ELECTRONICS CO., LTD., Suwon-si (KR)

(72) Inventors: Miao ZHOU, Beijing (CN); Feifei SUN, Beijing (CN); Min WU, Beijing (CN)

(21) Appl. No.: 18/897,323

(22) Filed: Sep. 26, 2024

(30) Foreign Application Priority Data
Sep. 28, 2023 (CN) 202311277074.5

(51) Int. Cl. H04W 72/044; H04W 72/0446; H04W 72/40

(52) U.S. Cl. CPC H04W 72/046; H04W 72/0446; H04W 72/40

(57) ABSTRACT

The disclosure relates to a 5G or 6G communication system for supporting a higher data transmission rate. Specifically, the disclosure related to a method and an apparatus in a wireless communication system are disclosed, the method including: receiving, a second UE, at least one reference signal from; measuring the at least one reference signal; and transmitting, to the second UE, first information related to at least one of: at least one preferred beam, and at least one time resource set, wherein the at least one time resource set is associated with at least one first beam.

### CROSS-REFERENCE TO RELATED APPLICATION

This application is based on and claims priority under 35 U.S.C. § 119 to Chinese Patent Application No. 202311277074.5 filed on Sep. 28, 2023, in the Chinese Intellectual Property Office, the disclosure of which is incorporated by reference herein in its entirety.

### BACKGROUND

### 1. Field

The present disclosure relates to the field of wireless communication technology, and more specifically, to a method and an apparatus for measuring a reference signal in a wireless communication system.

### 2. Description of Related Art

5^{th} generation (5G) mobile communication technologies define broad frequency bands such that high transmission rates and new services are possible, and can be implemented not only in “Sub 6 GHz” bands such as 3.5 GHZ, but also in “Above 6 GHz” bands referred to as mm Wave including 28 GHz and 39 GHz. In addition, it has been considered to implement 6G mobile communication technologies (referred to as Beyond 5G systems) in terahertz (THz) bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mm Wave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIOT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication. Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

### SUMMARY

The present disclosure relates to the field of wireless communication technology, and more specifically, to a method and an apparatus for measuring a reference signal in a wireless communication system.

According to an embodiment of the present disclosure, there is provided a method performed by a first user equipment (UE) in a wireless communication system including: receiving, from a second UE, at least one reference signal; measuring the at least one reference signal; and transmitting, to the second UE, first information related to at least one of: at least one preferred beam, and at least one time resource set, wherein the at least one time resource set is associated with at least one first beam.

In some embodiments, the at least one reference signal is transmitted on at least one second beam, and the measuring of the at least one reference signal includes measuring the at least one second beam.

In some embodiments, the first information further includes at least one of: measurement information related to the at least one reference signal, second information indicating at least one third beam, wherein the at least one third beam is selected by the first UE from at least one second beam, and the at least one third beam is at least one beam for a sidelink transmission between the first UE and the second UE, and third information indicating at least one fourth beam, wherein the at least one fourth beam includes at least one of: the at least one preferred beam, and the at least one third beam.

In some embodiments, the first UE indicates the at least one preferred beam in the first information by at least one of: including a set of beams in the first information, wherein the set of beams includes preferred beams; including N beam measurement information in the first information, wherein at least one or each of the N beam measurement information includes at least information indicating a beam and information indicating whether the beam is preferred beam, and wherein N is an integer greater than or equal to 1; including, in the first information, N beam measurement information and information indicating whether the N beam measurement information is for preferred beam; and including, in the first information, information related to preferred beam and no information related to other beams, according to a preset and/or preconfigured criterion.

In some embodiments, the first information indicates that the at least one preferred beam is based on at least one of: the first UE being preset and/or preconfigured to indicate only preferred beam and/or indicate preferred beam and non-preferred beam, the first UE being preset and/or preconfigured to preferentially indicate preferred beam, and a procedure performed by the first UE being one of initial beam acquisition, beam maintenance, and beam failure recovery.

In some embodiments, the method further includes: determining whether at least one fifth beam of the first UE and/or at least one second beam of the second UE is used as at least one of the at least one preferred beam and the at least one third beam, and/or determining whether the at least one fifth beam and/or the at least one third beam is indicated by the first information, wherein the at least one fifth beam is at least one beam for a sidelink transmission between the first UE and the second UE that is determined based on a result of the measurement.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

In order to illustrate the technical schemes of the embodiments of the present disclosure more clearly, the drawings of the embodiments of the present disclosure will be briefly introduced below. Apparently, the drawings described below only refer to some embodiments of the present disclosure, and do not limit the disclosure. In the drawings:

FIG. 1 illustrates an example of wireless network according to various embodiments of the present disclosure;

FIG. 2A illustrates an example of wireless transmission path according to various embodiments of the present disclosure;

FIG. 2B illustrates an example of wireless reception paths according to various embodiments of the present disclosure;

FIG. 3A illustrates an example of UE according to various embodiments of the present disclosure;

FIG. 3B illustrates an example of gNB according to various embodiments of the present disclosure;

FIG. 4 illustrates a flowchart of a method performed by a UE according to various embodiments of the present disclosure;

FIG. 5 illustrates a UE according to various embodiments of the present disclosure;

FIG. 6 illustrates a terminal according to various embodiments of the present disclosure; and

FIG. 7 illustrates a base station according to various embodiments of the present disclosure.

### DETAILED DESCRIPTION

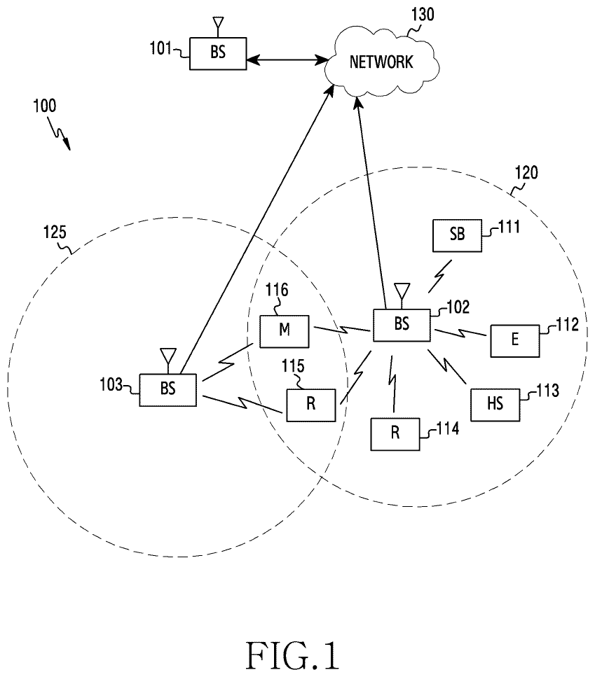

FIGS. 1 through 7, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

Accordingly, the embodiment herein is to provide a method performed by a first user equipment (UE) in a wireless communication system. The method includes receiving, from a second UE, at least one reference signal; measuring the at least one reference signal; and transmitting, to the second UE, first information related to at least one of: at least one preferred beam, and at least one time resource set. The at least one time resource set is associated with at least one first beam.

In an embodiment, by the UEs, the at least one reference signal is transmitted on at least one second beam, and the measuring of the at least one reference signal comprises measuring the at least one second beam.

In an embodiment, by the UEs, the first information further includes at least one of: measurement information related to the at least one reference signal, second information indicating at least one third beam, wherein the at least one third beam is selected by the first UE from at least one second beam, and the at least one third beam is at least one beam for a sidelink transmission between the first UE and the second UE, and third information indicating at least one fourth beam, wherein the at least one fourth beam includes at least one of: the at least one preferred beam, and the at least one third beam.

In an embodiment, by the UEs, the first UE indicates the at least one preferred beam in the first information by at least one of: including a set of beams in the first information, wherein the set of beams includes preferred beams; including N beam measurement information in the first information, wherein at least one or each of the N beam measurement information includes at least information indicating a beam and information indicating whether the beam is preferred beam, and wherein N is an integer greater than or equal to 1; including, in the first information, N beam measurement information and information indicating whether the N beam measurement information is for preferred beam; and including, in the first information, information related to preferred beam and no information related to other beams, according to a preset and/or preconfigured criterion.

In an embodiment, by the UEs, the first information indicates that the at least one preferred beam is based on at least one of: the first UE being preset and/or preconfigured to indicate only preferred beam and/or indicate preferred beam and non-preferred beam, the first UE being preset and/or preconfigured to preferentially indicate preferred beam, and a procedure performed by the first UE being one of initial beam acquisition, beam maintenance, and beam failure recovery.

In an embodiment, by the UEs, the method includes determining whether at least one fifth beam of the first UE and/or at least one second beam of the second UE is used as at least one of the at least one preferred beam and the at least one third beam, and/or determining whether the at least one fifth beam and/or the at least one third beam is indicated by the first information, wherein the at least one fifth beam is at least one beam for a sidelink transmission between the first UE and the second UE that is determined based on a result of the measurement.

In an embodiment, by the UEs, the determination comprises at least one of: determining that M beams with best results of the measurement are indicated by the first information, wherein M is an integer greater than or equal to 1, determining that M beams with best results of the measurement are used as the at least one preferred beam and/or the at least one third beam and/or the at least one fourth beam and/or the at least one fifth beam, and/or are indicated by the first information, determining that M beams with results of the measurement exceeding a first threshold are indicated by the first information, determining that M beams with results of the measurement exceeding a second threshold are used as the at least one preferred beam and/or the at least one third beam and/or the at least one fourth beam and/or the at least one fifth beam, and/or are indicated by the first information, determining that N beams with worst results of the measurement are indicated by the first information, determining that N beams with worst results of the measurement are used as non-preferred beams and indicated by the first information, wherein N is an integer greater than or equal to 0, determining that N beams with results of the measurement below a third threshold are indicated by the first information, determining that N beams with results of the measurement below a fourth threshold, or exceeding a fifth threshold and below the fourth threshold are indicated by the first information as non-preferred beams, and determining that beams which have been selected for communication with other UEs and/or beams which have been indicated as preferred beams or selected beams to other UEs are used as the at least one preferred beam and/or indicated by the first information.

In an embodiment, by the UEs, the first information indicates the at least one time resource set by indicating at least one of: a time-domain position of each time resource in the at least one time resource set, information of a periodic time resource or periodic time window, at least one information of a time window including at least one of: a start position of the time window, an end position of the time window, a length of the time window, an offset between the start position and/or the end position of the time window and a time point at which the first information is transmitted, and information related to a discontinuous reception (DRX) timer.

In an embodiment, by the UEs, the first information indicating the at least one time resource set comprises: indicating at least one beam corresponding to the at least one time resource set through the third information.

In an embodiment, by the UEs, the indicating of the at least one beam corresponding to the at least one time resource set through the third information comprises at least one of: indicating a beam associated with each time resource set of the at least one time resource set by a method in which one beam corresponds to one time resource set, and/or indicating a beam associated with multiple time resource sets of the at least one time resource set by a method in which one beam corresponds to multiple time resource sets; and indicating a beam corresponding to the at least one time resource set or a beam corresponding to each time resource set of the at least one time resource set based on a preset criterion or by an explicit indication or by an implicit indication.

In an embodiment, by the UEs, the method includes at least one of: in a case that the first UE indicates the at least one time resource set to the second UE, receiving a sidelink transmission on at least one time resource in the at least one time resource set with at least one reception beam currently used, and/or transmitting a sidelink transmission on at least one time resource in the at least one time resource set with at least one transmission beam currently used;

in a case that the first UE indicates the at least one time resource set and at least one reception beam of the first UE corresponding to the at least one time resource set to the second UE, receiving the sidelink transmission on at least one time resource in the at least one time resource set with the at least one reception beam; in a case that the first UE indicates the at least one time resource set and at least one transmission beam of the first UE corresponding to the at least one time resource set to the second UE, transmitting the sidelink transmission on at least one time resource in the at least one time resource set with the at least one transmission beam; and in a case that the first UE indicates the at least one time resource set and at least one transmission beam of the first UE corresponding to the at least one time resource set to the second UE, not indicating information related to a used transmission beam when the first UE transmits a sidelink signal or channel to the second UE on at least one time resource in the at least one time resource set.

In an embodiment, by the UEs, the first UE is triggered to measure the at least one reference signal and/or transmit the first information to the second UE in a case that at least one of the following conditions is satisfied: the first UE transmitting, to the second UE, signaling for requesting the second UE to transmit a reference signal for measurement, the first UE transmitting, to the second UE, the signaling for requesting the second UE to transmit the reference signal for measurement, and receiving a reference signal available for measurement from the second UE, the first UE receiving, from the second UE, signaling for requesting the first UE to transmit the first information, the first UE acquiring at least one resource location indicated by the second UE that is used to transmit the first information, the first UE receiving a set of resources indicated by the second UE that is used to measure and/or transmit the at least one reference signal, the first UE receiving the set of resources indicated by the second UE that is used to measure and/or transmit the at least one reference signal, and receiving the reference signal available for measurement from the second UE, the first UE being preset and/or preconfigured with a periodic measurement window, the first UE acquiring at least one measurement window, the first UE measuring at least K reference signals in a measurement window, wherein K is an integer greater than or equal to 1, the first UE measuring resources corresponding to the at least K reference signals in the measurement window, the first UE acquiring at least K measurement results with measurement values in a threshold range, at least one measurement window of the first UE ending, a measurement value of at least one second beam of the second UE by the first UE being below a seventh threshold, and/or being below the seventh threshold at least P1 times consecutively, and/or being below the seventh threshold at least P1 times within a specific time window, and a Physical Sidelink Shared Channel (PSSCH) transmission between the first UE and the second UE failing.

In an embodiment, by the UEs, the first UE is triggered to transmit to the second UE the signaling for requesting the second UE to transmit the reference signal for measurement in a case that at least one of the following conditions is satisfied: the first UE being preset and/or preconfigured with the periodic measurement window, the first UE acquiring the at least one measurement window, at least one measurement window of the first UE having started, or starting after at least t1 time units, or starting after at most t2 time units, the measurement value of the at least one second beam of the second UE by the first UE being below the seventh threshold, and/or being below the seventh threshold at least P1 times consecutively, and/or being below the seventh threshold at least P1 times within the specific time window, receiving a measurement value of at least one fifth beam of the first UE by the second UE, and the measurement value being below the seventh threshold, and/or being below the seventh threshold at least P1 times consecutively, and/or being below the seventh threshold at least P1 times within the specific time window, and the PSSCH transmission between the first UE and the second UE failing.

Accordingly, the embodiment herein is to provide a method performed by a second user equipment (UE) in a wireless communication system. The method includes transmitting, to a first UE, at least one reference signal; and receiving, from the first UE, first information related to at least one of: at least one preferred beam, and at least one time resource set. The at least one time resource set is associated with at least one first beam.

In an embodiment, by the UEs, the at least one reference signal is transmitted on at least one second beam.

In an embodiment, by the UEs, the first information further includes at least one of: measurement information related to the at least one reference signal, second information indicating at least one third beam, wherein the at least one third beam is selected by the first UE from at least one second beam, and the at least one third beam is at least one beam for a sidelink transmission between the first UE and the second UE, and third information indicating at least one fourth beam, wherein the at least one fourth beam includes at least one of: the at least one preferred beam, and the at least one third beam.

In an embodiment, by the UEs, the method includes at least one of: transmitting, to the first UE, signaling for requesting the first UE to transmit the first information; indicating, to the first UE, at least one resource location for the first UE to transmit the first information; and determining at least one sixth beam for a sidelink transmission with the first UE based on the first information.

In an embodiment, by the UEs, the second UE is triggered to transmit the at least one reference signal to the first UE, and/or to receive the first information from the first UE, and/or to transmit to the first UE signaling for requesting the first UE to transmit the first information, and/or to indicate to the first UE at least one resource location for the first UE to transmit the first information, and/or to determine at least one sixth beam for communicating with the first UE based on the first information, in a case that at least one of the following conditions is satisfied: the second UE receiving, from the first UE, signaling for requesting the second UE to transmit a reference signal for measurement, the second UE indicating, to the first UE, a set of resources for measuring and/or transmitting the at least one reference signal, the second UE indicating, to the first UE, the set of resources for measuring and/or transmitting the at least one reference signal and transmitting the at least one reference signal on the set of resources, the second UE being preset and/or preconfigured with a periodic resource, the second UE acquiring at least one resource, and the at least one resource being available for transmitting a reference signal for other UEs to measure, or the at least one resource being preset or preconfigured or determined to be used to transmit the reference signal for other UEs to measure, the second UE being preset and/or preconfigured with a periodic transmission window, the first UE acquiring at least one transmission window, the second UE transmitting at least K reference signals on a resource in a specific time and/or frequency range, the second UE acquiring a resource available for transmitting the at least K reference signals, at least one transmission window of the first UE having started, or starting after at least t1 time units, or starting after at most t2 time units, at least one transmission window of the second UE ending, a measurement value of at least one fifth beam of the first UE by the second UE being below a seventh threshold, and/or being below the seventh threshold at least P1 times consecutively, and/or being below the seventh threshold at least P1 times within a specific time window, wherein the at least one fifth beam is at least one beam determined based on a result of the measurement, a measurement value of at least one second beam of the second UE by the first UE being received, and the measurement value being below the seventh threshold, and/or being below the seventh threshold at least P1 times consecutively, and/or being below the seventh threshold at least P1 times within the specific time window, and a Physical Sidelink Shared Channel (PSSCH) transmission between the first UE and the second UE failing.

In an embodiment, by the UEs, the determining of the at least one sixth beam for communicating with the first UE based on the first information comprises at least one of: determining the at least one sixth beam among the at least one preferred beam; determining the at least one sixth beam based on whether a measurement value of the at least one reference signal exceeds a tenth threshold; determining the at least one sixth beam based on whether there is a beam that has been selected by the second UE for communicating with other UEs and/or a beam that has been indicated by the second UE to other UEs as preferred beam or selected beam among beams indicated by the first information; determining the at least one sixth beam according to whether the beams indicated by the first information have corresponding sensing results; and determining whether to use the beams indicated by the first information as the at least one sixth beam according to whether there is a time resource available for the first UE to transmit a sidelink signal or channel to the second UE in a time resource set corresponding to the beams.

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

The term “include” or “may include” refers to the existence of a corresponding disclosed function, operation or component which can be used in various embodiments of the present disclosure and does not limit one or more additional functions, operations, or components. The terms such as “include” and/or “have” may be construed to denote a certain characteristic, number, step, operation, constituent element, component or a combination thereof, but may not be construed to exclude the existence of or a possibility of addition of one or more other characteristics, numbers, steps, operations, constituent elements, components or combinations thereof.

The term “or” used in various embodiments of the present disclosure includes any or all of combinations of listed words. For example, the expression “A or B” may include A, may include B, or may include both A and B.

Unless defined differently, all terms used herein, which include technical terminologies or scientific terminologies, have the same meaning as that understood by a person skilled in the art to which the present disclosure belongs. Such terms as those defined in a generally used dictionary are to be interpreted to have the meanings equal to the contextual meanings in the relevant field of art and are not to be interpreted to have ideal or excessively formal meanings unless clearly defined in the present disclosure.

In order to meet the increasing demand for wireless data communication services since the deployment of 4G communication systems, efforts have been made to develop improved 5G or pre-5G communication systems. Therefore, 5G or pre-5G communication systems are also called “Beyond 4G networks” or “Post-LTE systems.”

In order to achieve a higher data rate, 5G communication systems are implemented in higher frequency (millimeter, mmWave) bands, e.g., 60 GHz bands. In order to reduce propagation loss of radio waves and increase a transmission distance, technologies such as beamforming, massive multiple-input multiple-output (MIMO), full-dimensional MIMO (FD-MIMO), array antenna, analog beamforming and large-scale antenna are discussed in 5G communication systems.

In addition, in 5G communication systems, developments of system network improvement are underway based on advanced small cell, cloud radio access network (RAN), ultra-dense network, device-to-device (D2D) communication, wireless backhaul, mobile network, cooperative communication, coordinated multi-points (COMP), reception-end interference cancellation, etc.

In 5G systems, hybrid FSK and QAM modulation (FQAM) and sliding window superposition coding (SWSC) as advanced coding modulation (ACM), and filter bank multicarrier (FBMC), non-orthogonal multiple access (NOMA) and sparse code multiple access (SCMA) as advanced access technologies have been developed.

In some embodiments, the determination includes at least one of:
determining that M beams with best results of the measurement are indicated by the first information, wherein M is an integer greater than or equal to 1,
determining that M beams with best results of the measurement are used as the at least one preferred beam and/or the at least one third beam and/or the at least one fourth beam and/or the at least one fifth beam, and/or are indicated by the first information,
determining that M beams with results of the measurement exceeding a first threshold are indicated by the first information,
determining that M beams with results of the measurement exceeding a second threshold are used as the at least one preferred beam and/or the at least one third beam and/or the at least one fourth beam and/or the at least one fifth beam, and/or are indicated by the first information,
determining that N beams with worst results of the measurement are indicated by the first information,
determining that N beams with worst results of the measurement are used as non-preferred beams and indicated by the first information, wherein Nis an integer greater than or equal to 0,
determining that N beams with results of the measurement below a third threshold are indicated by the first information,
determining that N beams with results of the measurement below a fourth threshold, or exceeding a fifth threshold and below the fourth threshold are indicated by the first information as non-preferred beams, and/or
determining that beams which have been selected for communication with other UEs and/or beams which have been indicated as preferred beams or selected beams to other UEs are used as the at least one preferred beam and/or indicated by the first information.

In some embodiments, the first information indicates the at least one time resource set by indicating at least one of:
a time-domain position of each time resource in the at least one time resource set, and/or
information of a periodic time resource or periodic time window,
at least one information of a time window including at least one of: a start position of the time window, an end position of the time window, a length of the time window, an offset between the start position and/or the end position of the time window and a time point at which the first information is transmitted, and/or
information related to a discontinuous reception (DRX) timer.

In some embodiments, the first information indicating the at least one time resource set includes: indicating at least one beam corresponding to the at least one time resource set through the third information.

In some embodiments, the indicating of the at least one beam corresponding to the at least one time resource set through the third information includes at least one of: indicating a beam associated with each time resource set of the at least one time resource set by a method in which one beam corresponds to one time resource set, and/or indicating a beam associated with multiple time resource sets of the at least one time resource set by a method in which one beam corresponds to multiple time resource sets; and indicating a beam corresponding to the at least one time resource set or a beam corresponding to each time resource set of the at least one time resource set based on a preset criterion or by an explicit indication or by an implicit indication.

In some embodiments, the method further includes at least one of:
in a case that the first UE indicates the at least one time resource set to the second UE, receiving a sidelink transmission on at least one time resource in the at least one time resource set with at least one reception beam currently used, and/or transmitting a sidelink transmission on at least one time resource in the at least one time resource set with at least one transmission beam currently used;
in a case that the first UE indicates the at least one time resource set and at least one reception beam of the first UE corresponding to the at least one time resource set to the second UE, receiving the sidelink transmission on at least one time resource in the at least one time resource set with the at least one reception beam;
in a case that the first UE indicates the at least one time resource set and at least one transmission beam of the first UE corresponding to the at least one time resource set to the second UE, transmitting the sidelink transmission on at least one time resource in the at least one time resource set with the at least one transmission beam; and/or
in a case that the first UE indicates the at least one time resource set and at least one transmission beam of the first UE corresponding to the at least one time resource set to the second UE, not indicating information related to a used transmission beam when the first UE transmits a sidelink signal or channel to the second UE on at least one time resource in the at least one time resource set.

In some embodiments, the first UE is triggered to measure the at least one reference signal and/or transmit the first information to the second UE in a case that at least one of the following conditions is satisfied:
the first UE transmitting, to the second UE, signaling for requesting the second UE to transmit a reference signal for measurement,
the first UE transmitting, to the second UE, the signaling for requesting the second UE to transmit the reference signal for measurement, and receiving a reference signal available for measurement from the second UE,
the first UE receiving, from the second UE, signaling for requesting the first UE to transmit the first information,
the first UE acquiring at least one resource location indicated by the second UE that is used to transmit the first information,
the first UE receiving a set of resources indicated by the second UE that is used to measure and/or transmit the at least one reference signal,
the first UE receiving the set of resources indicated by the second UE that is used to measure and/or transmit the at least one reference signal, and receiving the reference signal available for measurement from the second UE,
the first UE being preset and/or preconfigured with a periodic measurement window, the first UE acquiring at least one measurement window,
the first UE measuring at least K reference signals in a measurement window, wherein K is an integer greater than or equal to 1,
the first UE measuring resources corresponding to the at least K reference signals in the measurement window,
the first UE acquiring at least K measurement results with measurement values are in a threshold range,
at least one measurement window of the first UE ending,
a measurement value of at least one second beam of the second UE by the first UE being below a seventh threshold, and/or being below the seventh threshold at least P1 times consecutively, and/or being below the seventh threshold at least P1 times within a specific time window, and/or
a Physical Sidelink Shared Channel (PSSCH) transmission between the first UE and the second UE failing.

In some embodiments, the first UE is triggered to transmit to the second UE the signaling for requesting the second UE to transmit the reference signal for measurement in a case that at least one of the following conditions is satisfied:
the first UE being preset and/or preconfigured with the periodic measurement window,
the first UE acquiring the at least one measurement window,
at least one measurement window of the first UE having started, or starting after at least t1 time units, or starting after at most t2 time units,
the measurement value of the at least one second beam of the second UE by the first UE being below the seventh threshold, and/or being below the seventh threshold at least P1 times consecutively, and/or being below the seventh threshold at least P1 times within the specific time window,
receiving a measurement value of at least one fifth beam of the first UE by the second UE, and the measurement value being below the seventh threshold, and/or being below the seventh threshold at least P1 times consecutively, and/or being below the seventh threshold at least P1 times within the specific time window, and/or
the PSSCH transmission between the first UE and the second UE failing.

In some embodiments, the at least one first beam, the at least one second beam, the at least one third beam, the at least one fourth beam, the at least one fifth beam and the at least one preferred beam include at least one of at least one transmission beam of the first UE, at least one reception beam of the first UE, at least one transmission beam of the second UE, and at least one reception beam of the second UE.

According to an embodiment of the present disclosure, there is provided a method performed by a second user equipment (UE) in a wireless communication system including: transmitting, to a first UE, at least one reference signal; and receiving, from the first UE, first information related to at least one of: at least one preferred beam, and at least one time resource set, wherein the at least one time resource set is associated with at least one first beam.

In some embodiments, the at least one reference signal is transmitted on at least one second beam.

In some embodiments, the first information further includes at least one of: measurement information related to the at least one reference signal, second information indicating at least one third beam, wherein the at least one third beam is selected by the first UE from at least one second beam, and the at least one third beam is at least one beam for a sidelink transmission between the first UE and the second UE, and third information indicating at least one fourth beam, wherein the at least one fourth beam includes at least one of: the at least one preferred beam, and the at least one third beam.

In some embodiments, the method further includes at least one of: transmitting, to the first UE, signaling for requesting the first UE to transmit the first information; indicating, to the first UE, at least one resource location for the first UE to transmit the first information; and determining at least one sixth beam for a sidelink transmission with the first UE based on the first information.

In some embodiments, the second UE is triggered to transmit the at least one reference signal to the first UE, and/or to receive the first information from the first UE, and/or to transmit to the first UE signaling for requesting the first UE to transmit the first information, and/or to indicate to the first UE at least one resource location for the first UE to transmit the first information, and/or to determine at least one sixth beam for communicating with the first UE based on the first information, in a case that at least one of the following conditions is satisfied:
the second UE receiving, from the first UE, signaling for requesting the second UE to transmit a reference signal for measurement,
the second UE indicating, to the first UE, a set of resources for measuring and/or transmitting the at least one reference signal,
the second UE indicating, to the first UE, the set of resources for measuring and/or transmitting the at least one reference signal and transmitting the at least one reference signal on the set of resources,
the second UE being preset and/or preconfigured with a periodic resource,
the second UE acquiring at least one resource, and the at least one resource being available for transmitting a reference signal for other UEs to measure, or the at least one resource being preset or preconfigured or determined to be used to transmit the reference signal for other UEs to measure,
the second UE being preset and/or preconfigured with a periodic transmission window,
the first UE acquiring at least one transmission window,
the second UE transmitting at least K reference signals on a resource in a specific time and/or frequency range,
the second UE acquiring a resource available for transmitting the at least K reference signals,
at least one transmission window of the first UE having started, or starting after at least t1 time units, or starting after at most t2 time units, at least one transmission window of the second UE ending,
a measurement value of at least one fifth beam of the first UE by the second UE being below a seventh threshold, and/or being below the seventh threshold at least P1 times consecutively, and/or being below the seventh threshold at least P1 times within a specific time window, wherein the at least one fifth beam is at least one beam determined based on a result of the measurement,
a measurement value of at least one second beam of the second UE by the first UE being received, and the measurement value being below the seventh threshold, and/or being below the seventh threshold at least P1 times consecutively, and/or being below the seventh threshold at least P1 times within the specific time window, and/or
a physical sidelink shared channel (PSSCH) transmission between the first UE and the second UE failing.

In some embodiments, the determining of the at least one sixth beam for communicating with the first UE based on the first information includes at least one of:
determining the at least one sixth beam among the at least one preferred beam;
determining the at least one sixth beam based on whether a measurement value of the at least one reference signal exceeds a tenth threshold;
determining the at least one sixth beam based on whether there is a beam that has been selected by the second UE for communicating with other UEs and/or a beam that has been indicated by the second UE to other UEs as preferred beam or selected beam among beams indicated by the first information;
determining the at least one sixth beam according to whether the beams indicated by the first information have corresponding sensing results; and/or
determining whether to use the beams indicated by the first information as the at least one sixth beam according to whether there is a time resource available for the first UE to transmit a sidelink signal or channel to the second UE in a time resource set corresponding to the beams.

In some embodiments, the method further includes indicating the determined at least one sixth beam to the first UE, wherein the indication includes at least one of: indicating in Sidelink Control Information (SCI) a beam used by at least one Physical Sidelink Shared Channel (PSSCH) associated with the SCI; and indicating in a Medium Access Control (MAC) Control Element (CE) beams used by all sidelink signals or channels within a given time range.

In some embodiments, the at least one first beam, the at least one second beam, the at least one third beam, the at least one fourth beam, the at least one fifth beam, the at least one sixth beam, and the at least one preferred beam include at least one of at least one transmission beam of the first UE, at least one reception beam of the first UE, at least one transmission beam of the second UE, and at least one reception beam of the second UE.

According to an embodiment of the present disclosure, there is provided a user equipment (UE) including: a transceiver; and a controller coupled to the transceiver and configured to perform the aforementioned methods.

FIG. 1 illustrates an example of wireless network 100 according to various embodiments of the present disclosure. The embodiment of the wireless network 100 shown in FIG. 1 is for illustration only. Other embodiments of the wireless network 100 can be used without departing from the scope of the present disclosure.

The wireless network 100 includes a gNodeB (gNB) 101, a gNB 102, and a gNB 103. The gNB 101 communicates with the gNB 102 and the gNB 103. The gNB 101 also communicates with at least one Internet Protocol (IP) network 130, such as the Internet, a private IP network, or other data networks.

Depending on a type of the network, other well-known terms such as “base station” or “access point” can be used instead of “gNodeB” or “gNB.” For convenience, the terms “gNodeB” and “gNB” are used in this patent document to refer to network infrastructure components that provide wireless access for remote terminals. And, depending on the type of the network, other well-known terms such as “mobile station,” “user station,” “remote terminal,” “wireless terminal” or “user apparatus” can be used instead of “user equipment” or “UE.” For convenience, the terms “user equipment” and “UE” are used in this patent document to refer to remote wireless devices that wirelessly access the gNB, no matter whether the UE is a mobile device (such as a mobile phone or a smart phone) or a fixed device (such as a desktop computer or a vending machine).

The gNB 102 provides wireless broadband access to the network 130 for a first plurality of User Equipments (UEs) within a coverage area 120 of the gNB 102. The first plurality of UEs include a UE 111, which may be located in a Small Business (SB); a UE 112, which may be located in an enterprise (E); a UE 113, which may be located in a WiFi Hotspot (HS); a UE 114, which may be located in a first residence (R); a UE 115, which may be located in a second residence (R); a UE 116, which may be a mobile device (M), such as a cellular phone, a wireless laptop computer, a wireless PDA, etc. GNB 103 provides wireless broadband access to network 130 for a second plurality of UEs within a coverage area 125 of the gNB 103. The second plurality of UEs include a UE 115 and a UE 116. In some embodiments, one or more of gNBs 101-103 can communicate with each other and with UEs 111-116 using 5G, long term evolution (LTE), LTE-A, WiMAX or other advanced wireless communication technologies.

The dashed lines show approximate ranges of the coverage areas 120 and 125, and the ranges are shown as approximate circles merely for illustration and explanation purposes. It should be clearly understood that the coverage areas associated with the gNBs, such as the coverage areas 120 and 125, may have other shapes, including irregular shapes, depending on configurations of the gNBs and changes in the radio environment associated with natural obstacles and man-made obstacles.

As will be described in more detail below, one or more of the gNB 101, the gNB 102, and the gNB 103 include a 2D antenna array as described in embodiments of the present disclosure. In some embodiments, one or more of the gNB 101, the gNB 102, and the gNB 103 support codebook designs and structures for systems with 2D antenna arrays.

Although FIG. 1 illustrates an example of the wireless network 100, various changes can be made to FIG. 1. The wireless network 100 can include any number of gNBs and any number of UEs in any suitable arrangement, for example. Furthermore, the gNB 101 can directly communicate with any number of UEs and provide wireless broadband access to the network 130 for those UEs. Similarly, each gNB 102-103 can directly communicate with the network 130 and provide direct wireless broadband access to the network 130 for the UEs. In addition, the gNB 101, 102 and/or 103 can provide access to other or additional external networks, such as external telephone networks or other types of data networks.

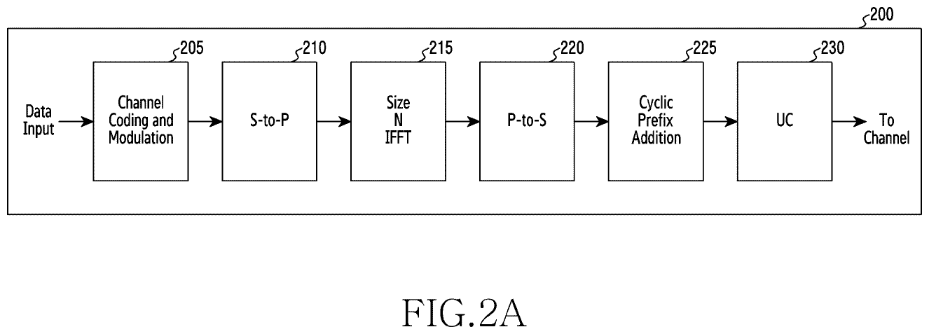

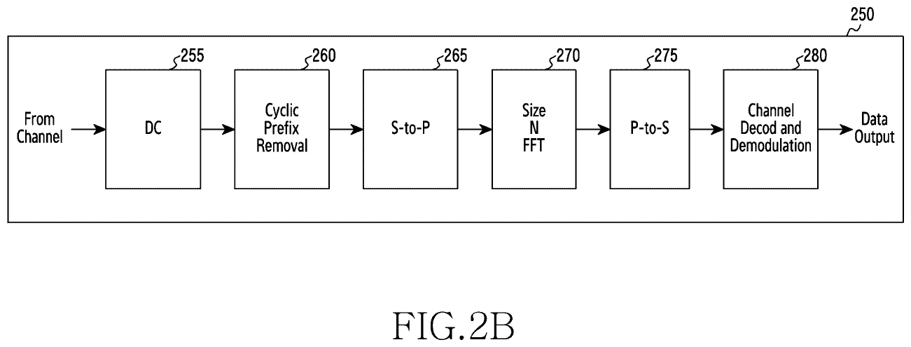

FIG. 2A illustrates an example of wireless transmission paths according to the various embodiments of the present disclosure. In the following description, the transmission path 200 can be described as being implemented in a gNB, such as the gNB 102. However, it should be understood that the transmission path 200 can be implemented in a UE.

The transmission path 200 includes a channel coding and modulation block 205, a serial-to-parallel (S-to-P) block 210, a size N inverse fast Fourier transform (IFFT) block 215, a Parallel-to-Serial (P-to-S) block 220, a cyclic prefix addition block 225, and an up-converter (UC) 230.

In the transmission path 200, the channel coding and modulation block 205 receives a set of information bits, applies coding (such as low density parity check (LDPC) coding), and modulates the input bits (such as using quadrature phase shift keying (QPSK) or quadrature amplitude modulation (QAM)) to generate a sequence of frequency-domain modulated symbols. The serial-to-parallel (S-to-P) block 210 converts (such as demultiplexes) serial modulated symbols into parallel data to generate N parallel symbol streams, where Nis a size of the IFFT/FFT used in the gNB 102 and the UE 116. The size N IFFT block 215 performs IFFT operations on the N parallel symbol streams to generate a time-domain output signal. The parallel-to-serial block 220 converts (such as multiplexes) parallel time-domain output symbols from the Ssze N IFFT block 215 to generate a serial time-domain signal. The cyclic prefix addition block 225 inserts a cyclic prefix into the time-domain signal. The up-converter 230 modulates (such as up-converts) the output of the cyclic prefix addition block 225 to an RF frequency for transmission via a wireless channel. The signal can also be filtered at a baseband before switching to the RF frequency.

FIG. 2B illustrates an example of wireless reception paths according to various embodiments of the present disclosure. In the following description, the reception path 250 can be described as being implemented in a UE, such as the UE 116. However, it should be understood that the reception path 250 can be implemented in a gNB and the transmission path 200 can be implemented in a UE. In some embodiments, the reception path 250 is configured to support codebook designs and structures for systems with 2D antenna arrays as described in embodiments of the present disclosure.

The reception path 250 includes a down-converter (DC) 255, a cyclic prefix removal block 260, a serial-to-parallel (S-to-P) block 265, a size N fast Fourier transform (FFT) block 270, a parallel-to-serial (P-to-S) block 275, and a channel decoding and demodulation block 280.

The RF signal transmitted from the gNB 102 arrives at the UE 116 after passing through the wireless channel, and operations in reverse to those at the gNB 102 are performed at the UE 116. The down-converter 255 down-converts the received signal to a baseband frequency, and the cyclic prefix removal block 260 removes the cyclic prefix to generate a serial time-domain baseband signal. The serial-to-parallel block 265 converts the time-domain baseband signal into a parallel time-domain signal. The size N FFT block 270 performs an FFT algorithm to generate N parallel frequency-domain signals. The parallel-to-serial block 275 converts the parallel frequency-domain signal into a sequence of modulated data symbols. The channel decoding and demodulation block 280 demodulates and decodes the modulated symbols to recover the original input data stream.

Each of gNBs 101-103 may implement a transmission path 200 similar to that for transmitting to UEs 111-116 in the downlink, and may implement a reception path 250 similar to that for receiving from UEs 111-116 in the uplink. Similarly, each of UEs 111-116 may implement a transmission path 200 for transmitting to gNBs 101-103 in the uplink, and may implement a reception path 250 for receiving from gNBs 101-103 in the downlink.

Each of the components in FIGS. 2A and 2B can be implemented using only hardware, or using a combination of hardware and software/firmware. As a specific example, at least some of the components in FIGS. 2A and 2B may be implemented in software, while other components may be implemented in configurable hardware or a combination of software and configurable hardware. For example, the FFT block 270 and IFFT block 215 may be implemented as configurable software algorithms, in which the value of the size N may be modified according to the implementation.

Furthermore, although described as using FFT and IFFT, this is only illustrative and should not be interpreted as limiting the scope of the present disclosure. Other types of transforms can be used, such as discrete Fourier transform (DFT) and inverse discrete Fourier transform (IDFT) functions. It should be understood that for DFT and IDFT functions, the value of variable N may be any integer (such as 1, 2, 3, 4, etc.), while for FFT and IFFT functions, the value of variable N may be any integer which is a power of 2 (such as 1, 2, 4, 8, 16, etc.).

Although FIGS. 2A and 2B illustrate examples of wireless transmission and reception paths, various changes may be made to FIGS. 2A and 2b. For example, various components in FIGS. 2A and 2B can be combined, further subdivided or omitted, and additional components can be added according to specific requirements. Furthermore, FIGS. 2A and 2B are intended to illustrate examples of types of transmission and reception paths that can be used in a wireless network. Any other suitable architecture can be used to support wireless communication in a wireless network.

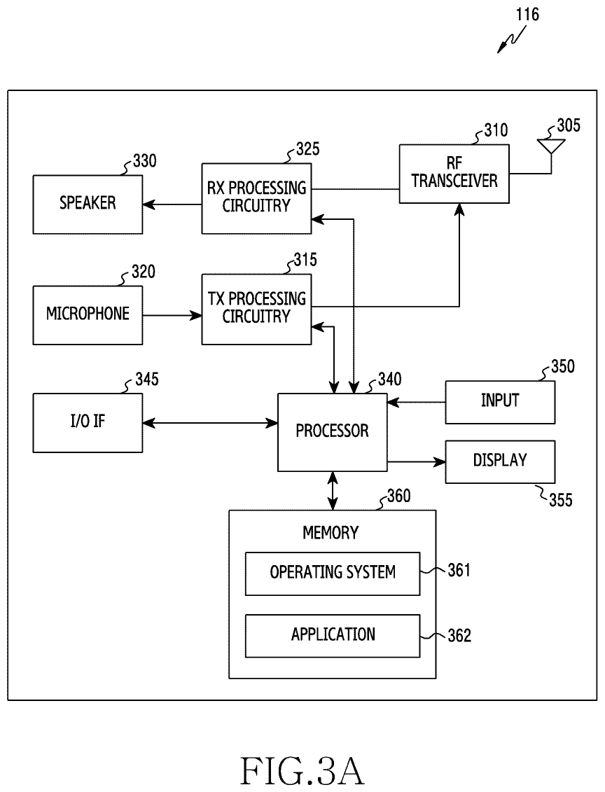

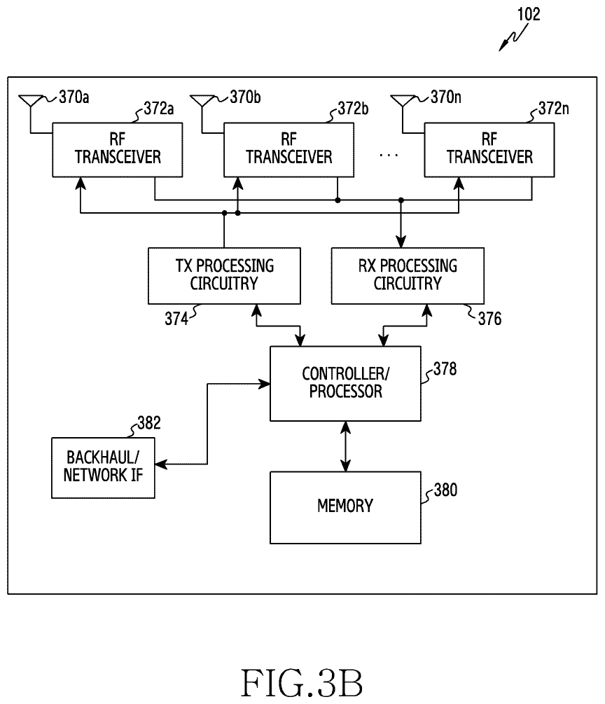

FIG. 3A illustrates an example of the UE 116 according to various embodiments of the present disclosure. The embodiment of the UE 116 shown in FIG. 3A is for illustration only, and UEs 111-115 of FIG. 1 can have the same or similar configuration. However, a UE has various configurations, and FIG. 3A does not limit the scope of the present disclosure to any specific implementation of the UE.

The UE 116 includes an antenna 305, a radio frequency (RF) transceiver 310, a transmission (TX) processing circuit 315, a microphone 320, and a reception (RX) processing circuit 325. The UE 116 also includes a speaker 330, a processor/controller 340, an input/output (I/O) interface 345, an input device(s) 350, a display 355, and a memory 360. The memory 360 includes an operating system (OS) 361 and one or more applications 362.

The RF transceiver 310 receives an incoming RF signal transmitted by a gNB of the wireless network 100 from the antenna 305. The RF transceiver 310 down-converts the incoming RF signal to generate an intermediate frequency (IF) or baseband signal. The IF or baseband signal is transmitted to the RX processing circuit 325, where the RX processing circuit 325 generates a processed baseband signal by filtering, decoding and/or digitizing the baseband or IF signal. The RX processing circuit 325 transmits the processed baseband signal to speaker 330 (such as for voice data) or to processor/controller 340 for further processing (such as for web browsing data).

The TX processing circuit 315 receives analog or digital voice data from microphone 320 or other outgoing baseband data (such as network data, email or interactive video game data) from processor/controller 340. The TX processing circuit 315 encodes, multiplexes, and/or digitizes the outgoing baseband data to generate a processed baseband or IF signal. The RF transceiver 310 receives the outgoing processed baseband or IF signal from the TX processing circuit 315 and up-converts the baseband or IF signal into an RF signal transmitted via the antenna 305.

The processor/controller 340 can include one or more processors or other processing devices and execute an OS 361 stored in the memory 360 in order to control the overall operation of the UE 116. For example, the processor/controller 340 can control the reception of forward channel signals and the transmission of backward channel signals through the RF transceiver 310, the RX processing circuit 325 and the TX processing circuit 315 according to well-known principles. In some embodiments, the processor/controller 340 includes at least one microprocessor or microcontroller.

The processor/controller 340 is also capable of executing other processes and programs residing in the memory 360, such as operations for channel quality measurement and reporting for systems with 2D antenna arrays as described in embodiments of the present disclosure. The processor/controller 340 can move data into or out of the memory 360 as required by an execution process. In some embodiments, the processor/controller 340 is configured to execute the application 362 based on the OS 361 or in response to signals received from the gNB or the operator. The processor/controller 340 is also coupled to an I/O interface 345, where the I/O interface 345 provides the UE 116 with the ability to connect to other devices such as laptop computers and handheld computers. I/O interface 345 is a communication path between these accessories and the processor/controller 340.

The processor/controller 340 is also coupled to the input device(s) 350 and the display 355. An operator of the UE 116 can input data into the UE 116 using the input device(s) 350. The display 355 may be a liquid crystal display or other display capable of presenting text and/or at least limited graphics (such as from a website). The memory 360 is coupled to the processor/controller 340. A part of the memory 360 can include a random access memory (RAM), while another part of the memory 360 can include a flash memory or other read-only memory (ROM).

Although FIG. 3A illustrates an example of the UE 116, various changes can be made to FIG. 3a. For example, various components in FIG. 3A can be combined, further subdivided or omitted, and additional components can be added according to specific requirements. As a specific example, the processor/controller 340 can be divided into a plurality of processors, such as one or more central processing units (CPUs) and one or more graphics processing units (GPUs). Furthermore, although FIG. 3A illustrates that the UE 116 is configured as a mobile phone or a smart phone, UEs can be configured to operate as other types of mobile or fixed devices.

FIG. 3B illustrates an example of the gNB 102 according to various embodiments of the present disclosure. The embodiment of the gNB 102 shown in FIG. 3B is for illustration only, and other gNBs of FIG. 1 can have the same or similar configuration. However, a gNB has various configurations, and FIG. 3B does not limit the scope of the present disclosure to any specific implementation of a gNB. It should be noted that the gNB 101 and the gNB 103 can include the same or similar structures as the gNB 102.

As shown in FIG. 3b, the gNB 102 includes a plurality of antennas 370a-370n, a plurality of RF transceivers 372a-372n, a transmission (TX) processing circuit 374, and a reception (RX) processing circuit 376. In certain embodiments, one or more of the plurality of antennas 370a-370n include a 2D antenna array. The gNB 102 also includes a controller/processor 378, a memory 380, and a backhaul or network interface 382.

RF transceivers 372a-372n receive an incoming RF signal from antennas 370a-370n, such as a signal transmitted by UEs or other gNBs. RF transceivers 372a-372n down-convert the incoming RF signal to generate an IF or baseband signal. The IF or baseband signal is transmitted to the RX processing circuit 376, where the RX processing circuit 376 generates a processed baseband signal by filtering, decoding and/or digitizing the baseband or IF signal. RX processing circuit 376 transmits the processed baseband signal to controller/processor 378 for further processing.

The TX processing circuit 374 receives analog or digital data (such as voice data, network data, email or interactive video game data) from the controller/processor 378. TX processing circuit 374 encodes, multiplexes and/or digitizes outgoing baseband data to generate a processed baseband or IF signal. RF transceivers 372a-372n receive the outgoing processed baseband or IF signal from TX processing circuit 374 and up-convert the baseband or IF signal into an RF signal transmitted via antennas 370a-370n.

The controller/processor 378 can include one or more processors or other processing devices that control the overall operation of the gNB 102. For example, the controller/processor 378 can control the reception of forward channel signals and the transmission of backward channel signals through the RF transceivers 372a-372n, the RX processing circuit 376 and the TX processing circuit 374 according to well-known principles. The controller/processor 378 can also support additional functions, such as higher-level wireless communication functions. For example, the controller/processor 378 can perform a Blind Interference Sensing (BIS) process such as that performed through a BIS algorithm, and decode a received signal from which an interference signal is subtracted. A controller/processor 378 may support any of a variety of other functions in the gNB 102. In some embodiments, the controller/processor 378 includes at least one microprocessor or microcontroller.

The controller/processor 378 is also capable of executing programs and other processes residing in the memory 380, such as a basic OS. The controller/processor 378 can also support channel quality measurement and reporting for systems with 2D antenna arrays as described in embodiments of the present disclosure. In some embodiments, the controller/processor 378 supports communication between entities such as web RTCs. The controller/processor 378 can move data into or out of the memory 380 as required by an execution process.

The controller/processor 378 is also coupled to the backhaul or network interface 382. The backhaul or network interface 382 allows the gNB 102 to communicate with other devices or systems through a backhaul connection or through a network. The backhaul or network interface 382 can support communication over any suitable wired or wireless connection(s). For example, when the gNB 102 is implemented as a part of a cellular communication system, such as a cellular communication system supporting 5G or new radio access technology or NR, LTE or LTE-A, the backhaul or network interface 382 can allow the gNB 102 to communicate with other gNBs through wired or wireless backhaul connections. When the gNB 102 is implemented as an access point, the backhaul or network interface 382 can allow the gNB 102 to communicate with a larger network, such as the Internet, through a wired or wireless local area network or through a wired or wireless connection. The backhaul or network interface 382 includes any suitable structure that supports communication through a wired or wireless connection, such as an Ethernet or an RF transceiver.

The memory 380 is coupled to the controller/processor 378. A part of the memory 380 can include an RAM, while another part of the memory 380 can include a flash memory or other ROMs. In certain embodiments, a plurality of instructions, such as the BIS algorithm, are stored in the memory. The plurality of instructions is configured to cause the controller/processor 378 to execute the BIS process and decode the received signal after subtracting at least one interference signal determined by the BIS algorithm.

As will be described in more detail below, the transmission and reception paths of the gNB 102 (implemented using RF transceivers 372a-372n, TX processing circuit 374 and/or RX processing circuit 376) support aggregated communication with FDD cells and TDD cells.

Although FIG. 3B illustrates an example of the gNB 102, various changes may be made to FIG. 3b. For example, the gNB 102 can include any number of each component shown in FIG. 3a. As a specific example, the access point can include many backhaul or network interfaces 382, and the controller/processor 378 can support routing functions to route data between different network addresses. As another specific example, although shown as including a single instance of the TX processing circuit 374 and a single instance of the RX processing circuit 376, the gNB 102 can include multiple instances of each (such as one for each RF transceiver).

In the long term evolution (LTE) technology, sidelink communication includes two main types of mechanisms including direct device to device (D2D) communication and vehicle to outside communication (vehicle to vehicle/infrastructure/pedestrian/network, collectively referred to as V2X), where the V2X communication is designed based on the D2D technology, is superior to the D2D in data rate, delay, reliability and link capacity, and is the most representative sidelink communication technology in LTE technology. In 5G systems, at present, sidelink communication mainly includes vehicle to outside (V2X) communication.

As the evolution technology of LTE, 5G NR systems also include the further evolution of sidelink communication accordingly, and NR V2X technology is formulated. As the evolution version of LTE V2X technology, NR V2X has superior performance in all aspects. 5G NR systems are expected to further expand the application scenarios of NR V2X to other broader application scenarios, e.g., commercial sidelink communication and public safety (PS) scenarios. The evolution of sidelink communication includes the direction of unlicensed frequency band, FR2, carrier aggregation, co-channel coexistence with LTE, etc., and also includes the support for technologies in other fields such as positioning.

In embodiments of the present application, information configured by a base station, information indicated by signaling, information configured by a higher layer, and preconfigured information include: a set of configuration information; multiple sets of configuration information, where the UE selects a set of configuration information therefrom for use according to a predefined condition; a set of configuration information including multiple subsets, where the UE selects a subset therefrom for use according to a predefined condition.

In embodiments of the present application, “lower than a threshold” may also be replaced by “lower than or equal to a threshold,” “higher than a threshold” may also be replaced by “higher than or equal to a threshold,” “less than or equal to” may also be replaced by “less than,” and “larger than or equal to” may also be replaced by “larger than,” and vice versa.

In embodiments of the present application, a part of the technical schemes provided are specifically described based on the V2X system, but their application scenarios should not be limited to the V2X system in sidelink communication, but may also be applied to other sidelink transmission systems. For example, the design based on V2X subchannels in the following embodiments may also be used for D2D subchannels or other subchannels for sidelink transmission. The V2X resource pool in the following embodiments may also be replaced by the D2D resource pool in other sidelink transmission systems such as the D2D.

In embodiments of the present application, when a sidelink communication system is the V2X system, a terminal or UE may be various types of terminals or UEs such as Vehicle, Infrastructure, and Pedestrian, etc.

A base station in the present disclosure may also be replaced by other nodes, such as sidelink nodes, and a specific example is an infrastructure UE in the sidelink system. Any mechanism applicable to the base station in the embodiments may also be similarly used in the scenario where the base station is replaced by other sidelink nodes, and the illustration will not be repeated.

A slot in the present disclosure may also be replaced by a time unit, a candidate slot may also be replaced by a candidate time unit, and a candidate slot resource may also be replaced by a candidate time unit resource. The time unit includes a specific time length, such as several consecutive symbols.

A slot in the present disclosure may be either a subframe or slot in a physical sense, or a subframe or slot in a logical sense. Specifically, the subframe or slot in the logical sense is a subframe or slot corresponding to a resource pool for sidelink communication. For example, in the V2X system, the resource pool is defined by a repeated bitmap mapped to a specific slot set, which may be all slots or all other slots except some specific slots (such as slots for transmitting an MIB (Master Information Block)/SIB (System Information Block)). A slot indicated as “1” in the bitmap may be used for V2X transmission and belongs to slots corresponding to the V2X resource pool. A slot indicated as “0” cannot be used for V2X transmission and does not belong to slots corresponding to the V2X resource pool.

The difference between the subframes or slots in the physical sense or those in the logical sense is illustrated by a typical application scenario below: when calculating the time-domain gap between two specific channels/messages (e.g., a PSSCH carrying sidelink data and a PSFCH carrying corresponding feedback information), and it is assumed that the gap is N slots, if calculating subframes or slots in the physical sense, the N slots correspond to the absolute time length of N*x milliseconds in time domain, and x is the time length of a physical slot (subframe) under the numerology of the scenario, in milliseconds; otherwise, if calculating subframes or slots in the logical sense, taking a sidelink resource pool defined by a bitmap as an example, the gap of N slots correspond to N slots indicated as “1” in the bitmap, and the absolute time length of the gap varies with the specific configuration of the sidelink communication resource pool, rather than a fixed value.

Further, a slot in the present disclosure may be a complete slot or several symbols corresponding to a sidelink communication in a slot. For example, when the sidelink communication is configured to be performed on the X1-X2-th symbols in each slot, in this scenario, a slot in the following embodiments refers to the X1-X2-th symbols in a slot; for another example, when the sidelink communication is configured to be transmitted in a mini-slot, in this scenario, a slot in the following embodiments refers to the mini-slot defined or configured in the sidelink system, rather than the slot in the NR system; for still another example, when the sidelink communication is configured as symbol-level transmission, in this scenario, a slot in the embodiments may be replaced by a symbol, or may be replaced by N symbols which are time-domain granularity of the symbol-level transmission.

In order to make the purpose, technical schemes and advantages of the present application clearer, the embodiments of the present application will be further described in detail with reference to the accompanying drawings.

In the disclosure, a UE acquires a configured or predefined/(pre) configured parameter, including at least one of acquiring from a higher layer, acquiring from a base station and acquiring from other UEs. For example, a second UE indicates a parameter to a first UE through higher layer signaling and/or physical layer signaling, which can be understood in the disclosure as that the first UE acquires a configuration of the parameter from the second UE.

In the disclosure, when a UE acquires or uses a threshold, the threshold may be predefined and/or configured. For the configured threshold, the configuration may be at least one of a higher layer configuration (such as RRC/MAC configuration), a base station configuration, a configuration from other UEs, and a preconfiguration.

In the present disclosure, a slot can also be replaced by other time units, such as an OFDM symbol, a mini-slot, a subframe, an OFDM symbol, etc. A subchannel can also be replaced by other frequency-domain units, such as a PRB, etc.

The text and drawings are provided as examples only to help readers understand the present disclosure. They are not intended and should not be interpreted as limiting the scope of the present disclosure in any way. Although certain embodiments and examples have been provided, based on the content disclosed herein, it is obvious to those skilled in the art that modifications to the illustrated embodiments and examples can be made without departing from the scope of the present disclosure.

In an LTE or NR sidelink communication system, the sidelink communication system is designed mainly based on the needs of specific D2D and vehicle business scenarios, and mainly uses low frequency bands, such as an intelligent transportation system (ITS) frequency band dedicated for vehicle transportation on FR1. With the development of 5G technologies, the business model of sidelink communication is growing, so it is necessary to enhance the sidelink communication technologies so that they can be applied to a wider range of application scenarios, such as XR, IIOT, RedCap, or the like. For the business requirements of some future application scenarios, the transmission rate, delay, and reliability that can be achieved by the current sidelink communication technologies need to be further enhanced. A feasible method is to introduce features such as beams in sidelink communication to increase the transmission rate supported by the sidelink system and improve the reliability, and to reduce the service transmission delay. However, the current sidelink communication system has not explored the possibility of sidelink communication using beams, and it also has not introduced any enhancement mechanisms for beams.

When the sidelink communication system uses beams for communication, it is necessary for the communicating UE to acquire and maintain the beams, and it is also necessary to select beams for receiving or transmitting during sidelink communication. Therefore, it is necessary to introduce a method for determining the beams in the procedure of beam acquisition, beam maintenance and/or beam failure recovery.

In the sidelink communication system using beams, if wireless communication is required between a first UE and a second UE, both the first UE and the second UE need to determine a beam used to communicate with each other, and use the beam to transmit a sidelink signal/channel to the peer UE, and receive a sidelink signal/channel therefrom. This beam further includes a transmission beam of the first UE or the second UE respectively, as well as a respective reception beam of the first UE or the second UE.

The UE may generally determine beams based on measurement results on the beams. A method for measuring beams is that a transmitting-end UE transmits a reference signal with its transmitting beam, a receiving-end UE performs measurement on the reference signal and provides a feedback result to the transmitting-end UE, and the transmitting-end UE and the receiving-end UE select a beam corresponding to the reference signal with the best communication quality based on the measurement result. The reference signal may be at least one of S-SSB, CSI-RS, DMRS; in the disclosure, the reference signal may also be replaced by other sidelink signals/channels, for example by at least one of PSCCH, PSSCH, PSFCH. Hereinafter, for convenience of description, the reference signal will still be used for explanation.

In the sidelink system of FR1, since it is not necessary to perform beam measurement, CSI-RS can typically be used to measure the channel quality of the FR1 air interface, which is defined to be multiplexed on the same time-frequency resource with data for transmission for overhead saving purposes. At least in the sidelink system of FR2, in order to support the increase in the number of CSI-RSs brought by the demand for beam measurement, and the purpose of transmitting and receiving CSI-RSs more flexibly to achieve instant channel measurement, in addition to the CSI-RSs multiplexed on data transmission in FR1, also referred to as non-independent CSI-RSs, there is a need to support CSI-RSs that may not be multiplexed with data, also referred to as independent CSI-RSs. The CSI-RS may be transmitted on the same slot and subchannel as PSCCH, PSFCH, and possibly PSSCH, which may be used to transmit 2nd stage SCI, and may be used to transmit higher layer control information not belonging to the data, such as MAC CE.

The procedure for the UE to determine beams includes initial beam acquisition, beam maintenance, beam failure recovery, and the like. The initial beam acquisition may be a procedure of initially determining a communication beam between communicating UEs, which generally includes performing beam scanning by both communicating UEs, acquiring at least one beam that can receive the other UE, and initiating communication based on the beam. The beam maintenance may be further maintaining of whether a beam is available and/or optimizing of a beam with better performance after the initial beam has been acquired between the communicating UEs, which generally includes continuing beam scanning between the communicating UEs, measuring and reporting the scanned beams, and selecting a better beam as a beam to be used for subsequent communication between the UEs based on the reported results.

Compared to the initial beam acquisition, a smaller number of beams may be scanned during the beam maintenance procedure, for example, only several candidate beams with better performance are maintained; it is also possible to use wider beams for scanning during the initial beam acquisition and finer beams for further beam optimization during the beam maintenance. The beam failure recovery procedure includes at least one of the communicating UEs detecting that the communication quality is poor (e.g., RS measurements to the other UE of the communication are below a threshold or persistently below a threshold, data channel transmission is persistently unsuccessful, etc.), triggering a reselection of beams, and transmitting a beam failure recovery request to the other UE to indicate the reselected beam; The other UE may transmit a response signal/channel according to the indicated reselected beam after receiving the beam failure recovery request, and if the response signal/channel is successfully received, the communication beam may be considered to be updated as the reselected beam and the beam failure recovery procedure terminates.

For convenience of description, the communicating sidelink UEs are referred to as a first UE and a second UE, which are a pair of UEs for which a communication connection is established. In any of the embodiments herein, the first UE may be one UE or may be multiple UEs, e.g., a group of UEs corresponding to a groupcast ID; similarly, the second UE may also be one or more UEs. The first UE and the second UE may each be a transmitting-end UE of data and/or a receiving-end UE of data.

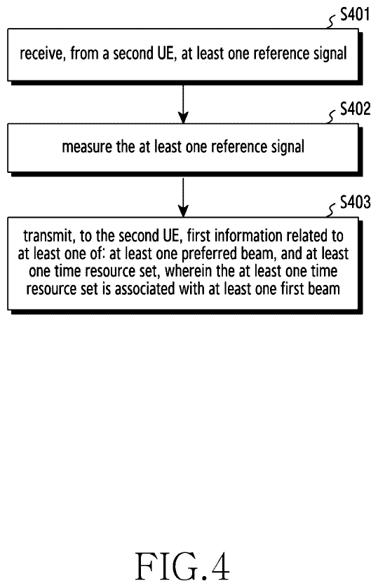

FIG. 4 illustrates a flowchart of a method performed by a UE according to various embodiments of the present disclosure.

In step S401, a first UE receives at least one reference signal from a second UE. In step S402, the first UE measures the at least one reference signal. In step S403, the first UE transmits, to the second UE, first information related to at least one of: at least one preferred beam, and at least one time resource set, wherein the at least one time resource set is associated with the at least one first beam. Through the above procedure, the first UE and the second UE may determine a beam suitable for a sidelink transmission, or determine the beam suitable for the sidelink transmission in a specific time resource.

Specifically, the second UE transmits the at least one reference signal to the first UE. The first UE performs a measurement on the reference signal from the second UE and acquires a measurement result corresponding to the reference signal or a measurement result corresponding to a beam transmitting the reference signal. In an exemplary embodiment, the first UE transmits first information including at least one beam measurement information to the second UE according to the measurement result; the second UE selects at least one beam for communication with the first UE according to the beam measurement information reported by the first UE. The method in the example may be used in a beam maintenance procedure. In another exemplary embodiment, the first UE selects at least one beam for communication with the second UE according to the measurement result, and transmits first information including the selected beam to the second UE; the second UE communicates with the first UE using the beam according to information of the beam indicated by the first UE. The method in the example may be used in a beam failure recovery procedure.

In the above method, the measurement result acquired by the first UE may belong to the same or different procedure as the first UE reporting the beam measurement information or selecting a beam and indicating the selected beam. For example, the first UE measures the reference signal from the second UE and acquires the measurement result in the beam maintenance procedure, and may use the measurement result acquired in the beam maintenance procedure to select the beam and indicate the selected beam to the second UE in the beam failure recovery procedure.

In the above method, the first UE transmits the first information to the second UE according to the measurement result, and the first information includes at least one of:
information used to indicate beams through the following information and/or information related to beams, which may be used to indicate at least one beam; further including at least one of information of a CSI-RS resource, information of an S-SSB, a beam index, a TCI status, QCL information; the information of the CSI-RS resource includes at least one of an ID, an index, a time-domain position, a frequency-domain position, an RE position of the CSI-RS resource, information of a sequence used by the CSI-RS; the information of the S-SSB includes at least one of an S-SSB index, an S-SSB resource position (including a time-domain position and/or a frequency-domain position), information of a sequence used by the S-SSB, information indicated in a PSBCH corresponding to the S-SSB; the beam may be at least one of a transmission beam of the first UE, a reception beam of the first UE, a transmission beam of the second UE, a reception beam of the second UE; the beam is indicated by the information of the CSI-RS resource and/or S-SSB resource, it may be understood that the indicated beam is a beam used for transmission and/or reception on the indicated CSI-RS resource and/or S-SSB resource;
a measurement value including at least one of: L1-RSRP, L1-SINR, hypothetical sidelink channel BLER; for the hypothetical sidelink channel BLER, the sidelink channel may be a sidelink signal and/or a sidelink channel including at least one of: PSCCH, PSSCH, PSBCH, 1st stage SCI, 2nd stage SCI, S-SSB; further, for a hypothetical BLER of PSCCH and/or 1st stage SCI and/or 2nd stage SCI, the hypothetical value may be calculated based on a specific SCI format; for an hypothetical PSSCH BLER, the hypothetical value may be calculated based on at least one of a specific MCS, a TBS, a frequency-domain size, a time-domain size; and for a hypothesized PSBCH BLER, the hypothesized value may be calculated based on contents of a specific PSBCH;
at least one preferred beam;
at least one non-preferred beam;
at least one selected beam for a transmission between the first UE and the second UE; and/or
at least one time resource set; a time resource set may include one or more time resources. Optionally, each time resource set corresponds to at least one reception beam of the first UE for indicating that the first UE may receive using the beam on the time resources in the set, and/or at least one transmission beam of the first UE for indicating that the first UE may transmit using the beam on the time resources in the set, and/or at least one transmission beam of the second UE for indicating that the second UE may transmit using the beam on the time resources in the set, and/or at least one reception beam of the second UE for indicating that the second UE may receive using the beam on the time resources in the set.

Optionally, in the above method, for any of the at least one preferred beam, the at least one non-preferred beam, the at least one beam for the transmission between the first UE and the second UE indicated in the first information, a method for indicating the at least one beam may be indicated by the above information for indicating beams; optionally, the beam may be at least one of a transmission beam of the first UE, a reception beam of the first UE, a transmission beam of the second UE, a reception beam of the second UE. Optionally, the beam may be determined according to at least one of the measurement results, the correspondence of the transmission and reception beams, the correspondence of the communication beams of the first UE and the second UE, for example, the transmission beam of the second UE and/or the reception beam of the first UE is determined according to the measurement results, for another example, the reception beam of the first UE is determined according to the determined transmission beam of the second UE and the correspondence between the transmission beam of the second UE and the reception beam of the first UE, for another example, the reception beam of the second UE is determined according to the transmission beam of the second UE and the correspondence of the transmission beam and the reception beam, and the transmission beam of the first UE is determined according to the reception beam of the first UE and the correspondence of the transmission beam and the reception beam. Thus, while the first UE measures the transmission beam of the second UE in the example, the beam indicated by the first UE to the second UE may be any one or more of the transmission beam of the first UE, the reception beam of the first UE, the transmission beam of the second UE, and the reception beam of the second UE.

Optionally, the first UE indicates the at least one preferred beam and/or the at least one non-preferred beam to the second UE through the first information, including indicating based on at least one of:
including a set of beams (the set of beams may also be replaced by at least one of: at least one beam, a subset of a specific/preset set of beams, at least one beam group, at least one beam sub-group) in the first information, beams included in the set being preferred beams or non-preferred beams. A method for indicating the beams in the set includes at least one of: indicating based on information for indicating beams in the first information, for example, each beam in the set is indicated by a corresponding CSI-RS resource index, i.e., the set may be understood as a set of CSI-RS resource indexes; and/or, the beams in the set are indicated based on beams indicated in the first information, for example, a total of N beams (or N information for indicating beams, and the following is similar) are indicated in the first information, and the set includes a bitmap with a length of N bits, each bit corresponding to one of the total of N beams in order, for another example, a total of N beams are indicated in the first information, the set includes several fields with a length of N′ bits, each field indicating an order (e.g., first, second, . . . ) of a beam in the total of N beams, where N′=log 2(N) or log 2(N) rounded up. In addition, the first UE and/or the second UE also need to distinguish that the set of beams is a set of preferred beams or a set of non-preferred beams. Optionally, the set of beams is a set of preferred beams or a set of non-preferred beams according to a preset criterion; and/or the set of beams is indicated to correspond to preferred beams or non-preferred beams by a field, e.g., by 1 bit, and/or by a specific status value of a certain SCI field, and/or by a different SCI format, and/or by an index of a scrambled sequence, and/or by a different RNTI;
including N beam measurement information (N is a positive integer greater than or equal to 1) in the first information, at least one or each of the N beam measurement information including at least information for indicating beams and information for indicating whether the beams are preferred beams. For example, a CSI-RS resource index field, an L1-RSRP measurement value field, and a 1-bit field indicating preferred/non-preferred beam are included in each reported beam measurement information;
including N beam measurement information (N is a positive integer greater than or equal to 1) and indication information for indicating that the N beam measurement information is for preferred beam or non-preferred beam in the first information; further, the indication information may be indicated by 1 bit, and/or a specific status value of a certain SCI field, and/or a different SCI format, and/or an index of a scrambled sequence, and/or a different RNTI. The difference compared to the above including of at least the information for indicating beams and the information for indicating whether the beams are preferred beams in at least one or each of the N beam measurement information is that the previous method can be understood as using N bits (which can be an explicit field or an implicit indication method) to indicate that the N beam measurement information corresponds to preferred/non-preferred beam, respectively, and the method here can be understood as using 1 bit to indicate that all the N beam measurement information corresponds to preferred/non-preferred beam; and/or
information reported by the first UE being information of preferred beam or the information reported by the first UE being information of non-preferred beam, according to preset and/or (pre) configured criterions.

Optionally, the method in which the first UE indicates the at least one preferred beam and/or the at least one non-preferred beam to the second UE through the first information may be indicated based on at least one of:
being preset and/or (pre) configured to indicate only preferred beams, and/or to indicate only non-preferred beams, and/or to indicate both preferred beams and non-preferred beams;
being preset and/or (pre) configured to preferentially indicate preferred beams, and optionally, to indicate other beams and/or non-preferred beams in the first information when there are no preferred beams or the number of preferred beams is below a threshold; or being preset and/or (pre) configured to preferentially indicate non-preferred beams, and optionally, to indicate other beams and/or preferred beams in the first information when there are no non-preferred beams or the number of non-preferred beams is below a threshold; the threshold may be preset and/or (pre) configured; and/or
determining to indicate preferred beams and/or non-preferred beams based on which of initial beam acquisition, beam maintenance, beam failure recovery the performed procedure is.

Optionally, the first UE indicating the information related to the at least one beam and/or related information for indicating at least one of preferred beam, non-preferred beam, selected beam for the transmission between the first UE and the second UE in the first information further includes determining whether at least one beam of the first UE and/or at least one beam of the second UE can be used as any of the above beams and/or related information thereof is included in the first information, and the method for the determination includes at least one of:
determining that M beams with best corresponding measurement results (e.g., highest L1-RSRP/L1-SINR, lowest hypothetical sidelink channel BLER) are indicated in the first information, and/or determining that the M beams with best corresponding measurement results are indicated in the first information as at least one preferred beam and/or the beam for the transmission between the first UE and the second UE, where M is a positive integer greater than or equal to 1. Optionally, the value of M and/or the maximum value and/or minimum value of M is preset and/or (pre) configured, and may be configured by the configuration information of a higher layer/the second UE/a resource pool. Optionally, when the first UE indicates to the second UE preferred beam and/or the beam for the transmission between the first UE and the second UE, and does not indicate non-preferred beam, it is determined that the M beams with best corresponding measurement results are indicated in the first information;
determining that M beams with corresponding measurement results exceeding a first threshold are indicated in the first information, and/or determining that M beams with corresponding measurement results exceeding a second threshold are indicated in the first information as at least one preferred beam and/or the beam for the transmission between the first UE and the second UE, where M is a non-negative integer greater than or equal to 0. Optionally, at least one of the value of M, the maximum value of M, the minimum value of M, the first threshold, the second threshold is preset and/or (pre) configured, and may be configured by the configuration information of a higher layer/the second UE/a resource pool; the first threshold and the second threshold may be preset and/or (pre) configured separately or together (e.g., configured by the same field), or one is determined by the other, for example, the second threshold is the first threshold minus a preset/(pre) configured offset. Optionally, the M beams are all beams exceeding the threshold, or M beams selected among all beams exceeding the threshold (e.g., when the number M1 of beams exceeding the threshold exceeds a configured value of M), which may be randomly selected or selected according to other methods in the disclosure. Optionally, when the first UE indicates to the second UE preferred beam and/or the beam for the transmission between the first UE and the second UE, and does not indicate non-preferred beam, it is determined that the M beams with best corresponding measurement results exceeding the first threshold are indicated in the first information;
determining that N beams with worst corresponding measurement results are indicated in the first information, and/or determining that the N beams with worst corresponding measurement results are indicated in the first information as non-preferred beams, where N is a non-negative integer greater than or equal to 0. Optionally, the value of N and/or the maximum value and/or minimum value of N is preset and/or (pre) configured, and may be configured by the configuration information of a higher layer/the second UE/a resource pool. Optionally, when the first UE indicates non-preferred beam to the second UE, it is determined that the N beams with worst corresponding measurement results are indicated in the first information;
determining that N beams with corresponding measurement results below a third threshold are indicated in the first information, and/or determining that the N beams with corresponding measurement results below a fourth threshold, or exceeding a fifth threshold and below the fourth threshold are indicated in the first information as non-preferred beams, where N is a non-negative integer greater than or equal to 0. Optionally, at least one of the value of N, the maximum value of N, the minimum value of N, the third threshold, the fourth threshold, the fifth threshold is preset and/or (pre) configured, and may be configured by the configuration information of a higher layer/the second UE/a resource pool; the third threshold, the fourth threshold, the fifth threshold may be preset and/or (pre) configured separately, and/or at least two of them are preset and/or (pre) configured together (e.g., configured by the same field), and/or one of them is determined by at least one of the other, for example, the fourth threshold is the third threshold minus a preset/(pre) configured offset. Optionally, the N beams are all beams below the threshold, or N beams selected among all beams below the threshold (e.g., when the number N1 of beams exceeding the threshold exceeds a configured value of N), which may be randomly selected or selected according to other methods in the disclosure. Optionally, when the first UE indicates non-preferred beam to the second UE, it is determined that the N beams with corresponding measurement results below the third threshold are indicated in the first information; and/or
determining that beams which have been selected for communication with other UEs, and/or beams which have been indicated to other UEs as preferred/selected beams are used as the at least one preferred beam and/or are indicated in the first information. The method may be further combined with other methods in the disclosure, for example, when a beam has been selected for communication with other UEs and/or has been indicated to other UEs as preferred/selected beam, and the beam belongs to one of M beams with best measurement results and/or the measurement result of the beam exceeds the first threshold, the beam is indicated in the first information as at least one preferred beam and/or the selected beam for the transmission between the first UE and the second UE. Optionally, if the first UE determines multiple beams that have been selected for communication with other UEs, and/or multiple beams that have been indicated to other UEs as preferred/selected beams, one or M beams are selected therein to be indicated in the first information, including selecting according to at least one of: selecting one or M beams with best corresponding measurement results, selecting M beams with corresponding measurement results exceeding the first threshold, excluding (or not selecting) N beams with worst corresponding measurement results, excluding (or not selecting) N beams with corresponding measurement results below the sixth threshold, selecting one or M beams used for communication for the maximum number of UEs, selecting one or M beams indicated as preferred/selected beams for the maximum number of UEs. The sixth threshold may be preset and/or (pre) configured separately from the first to fifth thresholds or preset and/or (pre) configured together with at least one of the thresholds, or determined by other thresholds, e.g., the sixth threshold is the first threshold minus a preset/(pre) configured offset.

For the method for determining whether a beam is included in the first information and is used as at least one preferred beam and/or selected as a beam for the transmission between the first UE and the second UE based on whether the beam is selected for communication with other UEs and/or has been indicated as preferred/selected beam to other UEs of the above methods, further, the method may be used in combination with other methods, for example, a part of the preferred beams is determined using the method and another part of the preferred beams is determined using other methods; for another example, K1 preferred beams indicated in the first information are determined using the method, and M-K1 other beams indicated in the first information are determined using other methods, which may be included in the first information but not included in the set of preferred beams, and may also be included in the first information and not indicated as preferred beams or indicated as non-preferred beams.

For the method for determining whether a beam is included in the first information and is used as at least one preferred beam and/or selected as a beam for the transmission between the first UE and the second UE based on whether the beam is selected for communication with other UEs and/or has been indicated as preferred/selected beam to other UEs of the above methods, it is advantageous that in scenarios in which a base station communicates with a UE, since the UE typically only needs to maintain an RRC connection with the base station (when the UE has multiple serving cells, the UE may still be considered to maintain only one RRC connection with a base station of the cell for each serving cell due to base stations of the multiple serving cells scheduling resources respectively), the link quality reflected by the measurement value can be used as the only criterion for selecting a communication beam between the base station and the UE, and other considerations can be ignored. However, in UE-to-UE sidelink communication scenarios, it is more common that one UE needs to maintain multiple RRC connections with multiple other UEs, including multiple RRC unicast connections and one or more RRC groupcast connections. Thus, different beams used between different RRC connections (i.e., different UE pairs) may suffer from conflicting with each other.

For example, UE0 selects to communicate with UE1 using transmission and reception beam #1 and communicate with UE2 using transmission and reception beam #2 according to the link quality, but UE1 and UE2 select different frequency-domain resources on the same slot to transmit data to UE0, and at this time, reception beams #1 and #2 of UE0 collide, UE0 can select only one of reception beams #1 and #2 to receive data on the slot, and may not receive data corresponding to the other reception beam. Thus, using whether a beam is used for communication with other UEs and/or has been indicated to other UEs as preferred/selected beam as one of the criterions for selecting a beam, the risk of beam collision may be mitigated. In the following, the reception beam collision is used as an example for explanation. UE0 selects to communicate with UE1 using transmission and reception beam #1 according to the link quality, and if the measurement results of both reception beams #1 and #2 are measured to satisfy the condition (e.g., exceed the first or second threshold) when determining the beam used with UE2, and reception beam #1 has been used for communication with other UEs, reception beam #1 is selected as the communication beam with UE2 accordingly, then the reception beam collision in the previous example can be avoided. Similarly, since the UE cannot transmit multiple channels using different transmission beams at the same time, the problem of transmission beam collision may also occur in the sidelink communication system, and this method may similarly mitigate the risk of transmission beam collision.

Optionally, the first UE indicating the at least one time resource set to the second UE through the first information includes indicating based on at least one of:
indicating a time-domain position of each resource in the set, which may be indicated by a similar field based on a method of indicating the time-domain resource position in SCI and/or inter-UE coordination information. Optionally, at least one frequency-domain resource position corresponding to each resource in the set is also indicated in the first information, and the method may be understood as indicating at least one set of time-frequency resources;
indicating a periodic time resource or a periodic time window, which may be indicated by at least one of the following of the time resource/time window: a start position, an end position, a period, an offset (within the period), a length of the time window, a number of consecutive time resources included in the set, a bitmap for indicating whether a time resource belongs to the set;
indicating a time window, including indicating at least one of the following of the time window: a start position, an end position, a length of the time window, an offset between the start position and/or the end position of the time window and a time point at which the first information is transmitted; and/or
reusing a mechanism of discontinuous reception (DRX), indicating at least one time resource set by a DRX timer, wherein a DRX activation time corresponds to a resource included in the time resource set. The DRX timer may be configured separately from existing DRX timers, e.g., configuring a corresponding new timer for at least one beam by RRC to indicate the available (available for reception/transmission) and unavailable time of the beam.

Optionally, the first UE indicating the beam corresponding to the at least one time resource set to the second UE through the first information includes indicating through the information for indicating beams, which further includes at least one of:
indicating one respective beam for each time resource set or multiple time resource sets in a one-to-one correspondence (e.g., one beam for one time resource set) or in a one-to-many correspondence (e.g., one beam for multiple time resource sets) manner; for example, a field of corresponding beam information is indicated for each set when N time resource sets are indicated; and/or
indicating beams corresponding to the at least one time resource set or a beam corresponding to each of the at least one time resource set based on a preset criterion, or by an explicit indication, e.g., 1 bit or 2 bits, or by an implicit indication, e.g., indicating a channel of the first information and/or an SCI format corresponding to the first information, which may be at least one of a transmission beam of the first UE, a reception beam of the first UE, a transmission beam of the second UE, a reception beam of the second UE.

Optionally, if the first UE indicates at least one time resource set to the second UE (and does not indicate beams corresponding thereto), which may be considered to correspond to time resources in which at least one beam currently used for communication may be used for reception and/or transmission, the first UE may receive a sidelink transmission using at least one reception beam currently used for communication with the second UE on the time resource set, and/or the second UE may transmit a sidelink transmission to the first UE using at least one transmission beam currently used for communication with the first UE on the time resource set.

Optionally, if the first UE indicates at least one time resource set to the second UE (and does not indicate beams corresponding thereto), which may be considered to correspond to time resources in which at least one beam currently used for communication may be used for reception and/or transmission, the first UE transmits a sidelink transmission using at least one transmission beam currently used for communication with the second UE on the time resource set, and/or the second UE may receive a sidelink transmission from the first UE using at least one reception beam currently used for communication with the first UE on the time resource set.

Optionally, if the first UE indicates to the second UE at least one time resource set and at least one reception beam of the first UE and/or at least one transmission beam of the second UE corresponding to the set, the first UE receives a sidelink transmission using the at least one reception beam on the time resource set, and/or the second UE may transmit a sidelink transmission to the first UE using the at least one transmission beam on the time resource set.

Optionally, if the first UE indicates to the second UE at least one time resource set and at least one transmission beam of the first UE and/or at least one reception beam of the second UE corresponding to the set, the first UE transmits a sidelink transmission using the at least one transmission beam on the time resource set, and/or the second UE may receive a sidelink transmission from the first UE using the at least one reception beam on the time resource set.

Optionally, if the first UE indicates to the second UE at least one time resource set and at least one reception beam of the first UE and/or at least one transmission beam of the second UE corresponding to the set, the second UE may not indicate information related to the used transmission beam when transmitting the sidelink signal/channel to the first UE on the time resource set; and/or, if the first UE indicates to the second UE at least one time resource set and at least one transmission beam of the first UE and/or at least one reception beam of the second UE corresponding to the set, the first UE may not indicate information related to the used transmission beam when transmitting the sidelink signal/channel to the second UE on the time resource set.

Optionally, if the time resource set and the beams are indicated through higher layer signaling such as MAC CE or RRC signaling, the first UE and/or the second UE may use the above method of not indicating the information related to the transmission beam after the first UE receives ACK feedback corresponding to the higher layer signaling and/or after the second UE transmits ACK feedback corresponding to the higher layer signaling; otherwise if ACK feedback is not received/transmitted, or NACK feedback is received/transmitted, the first UE and/or the second UE cannot use the above method of not indicating the information related to the transmission beam.

Optionally, if the time resource set and the beams are indicated by higher layer signaling such as MAC CE or RRC signaling, the first UE and/or the second UE may use the above method of not indicating the information related to the transmission beam after adding a time offset to a time point at which the higher layer signaling is transmitted; and/or the first UE and/or the second UE cannot use the above method of not indicating the information related to the transmission beam within a time period from the time point at which the higher layer signaling is transmitted to the time point at which the higher layer signaling is transmitted plus the time offset. The time offset may be preset and/or (pre) configured.

Optionally, the first UE is triggered to measure the reference signal from the second UE and/or transmit the first information to the second UE when at least one of the following conditions is satisfied:
the first UE transmitting, to the second UE, signaling for requesting the second UE to transmit a reference signal for measurement; or the first UE transmitting, to the second UE, the signaling for requesting the second UE to transmit the reference signal for measurement and receiving a reference signal available for measurement from the second UE;
receiving, from the second UE, signaling for requesting the first UE to transmit the first information, and/or acquiring at least one resource location indicated by the second UE for transmitting the first information;
receiving a set of resources indicated by the second UE for measurement and/or for transmitting the reference signal, e.g., several CSI-RS resources indicated for measurement by the first UE; or receiving a set of resources indicated by the second UE for measurement and/or for transmitting the reference signal, and receiving a reference signal available for measurement from the second UE; optionally, the set of resources indicated by the second UE is a set of resources transmitted to the first UE, e.g., a destination ID in SCI corresponding to the indication is an ID of the first UE;
the first UE being preset and/or (pre) configured with periodic measurement windows, and/or the first UE acquiring at least one measurement window, which may be indicated to the first UE by the second UE;
the first UE, in the measurement window, measuring at least K reference signals, where K is an integer greater than or equal to 1, and/or measuring resources corresponding to the at least K reference signals, and/or acquiring at least K measurement results with measurement values in a threshold range, wherein the threshold range may correspond to at least one of the first to sixth thresholds corresponding to the beams indicated by the first information in the disclosure; for example, the first UE measures the reference signal and acquires at least K measurement results with L1-RSRP exceeding the first threshold in the measurement window;
at least one measurement window of the first UE ending; the method may be interpreted as the first UE attempting to measure the reference signal from the second UE in each or at least one measurement window and reporting a measurement result through the first information after the end of the measurement window; in a specific example, the method is used in combination with the previous method, i.e., at least one measurement window of the first UE ends and the first UE measures at least K reference signals and/or measures resources corresponding to the at least K reference signals and/or acquires at least K measurement results with measurement values in a threshold range in the at least one measurement window, the first UE is triggered to transmit the first information to the second UE;
a measurement value of at least one beam of the second UE by the first UE being below a seventh threshold, and/or being below the seventh threshold at least P1 times consecutively, and/or being detected to be below the seventh threshold at least P1 times within a time window having a length in an eighth threshold range. P1 and/or the seventh threshold and/or the eighth threshold range may be preset and/or (pre) configured. The at least one beam may be a beam that has been used by the first UE to communicate with the second UE, or a corresponding beam thereof. For example, the beam used by the first UE to communicate with the second UE is transmission beam #1 of the first UE, which corresponds to reception beam #1 of the first UE, transmission beam #5 of the second UE, then when a measurement value of transmission beam #5 of the second UE by the first UE is below the seventh threshold, the condition is satisfied; and/or
a PSSCH transmission between the first UE and the second UE failing, which further includes at least P2 consecutive transmission/reception failures, and/or detecting at least P2 transmission/reception failures within a time window having a length in a ninth threshold range. The transmission/reception failures include at least one of reception of NACK, transmission of NACK, non-reception of ACK feedback (the condition may correspond to a PSSCH using other HARQ-ACK feedback methods than NACK-only groupcast). P2 and/or the ninth threshold range may be preset and/or (pre) configured. The eighth and ninth threshold ranges may be the same and/or configured together, or may be different and/or configured separately.

Optionally, the first UE is triggered to transmit to the second UE the signalling for requesting the second UE to transmit the reference signal for measurement when at least one of the following conditions is satisfied:
the first UE being preset and/or (pre) configured with periodic measurement windows, and/or the first UE acquiring at least one measurement window, which may be indicated to the first UE by the second UE;
at least one measurement window of the first UE having started, or starting after at least t1 time units, or starting after at most t2 time units, where the time units may be physical slots, or logical slots, or physical time units such as milliseconds;
a measurement value of at least one beam of the second UE by the first UE being below the seventh threshold, and/or being below the seventh threshold at least P1 times consecutively, and/or being detected to be below the seventh threshold at least P1 times within a time window having a length in the eighth threshold range; and/or receiving a measurement value of at least one beam of the first UE by the second UE that is transmitted by the second UE and the measurement value being below the seventh threshold and/or being below the seventh threshold at least P1 times consecutively and/or being detected to be below the seventh threshold at least P1 times within a time window having a length in the eighth threshold range. P1 and/or the seventh threshold and/or the eighth threshold range may be preset and/or (pre) configured. The at least one beam may be a beam that has been used by the first UE to communicate with the second UE, or a corresponding beam thereof. For example, the beam used by the first UE to communicate with the second UE is transmission beam #1 of the first UE, which corresponds to reception beam #1 of the first UE, transmission beam #5 of the second UE, then when a measurement value of transmission beam #5 of the second UE by the first UE is below the seventh threshold, the condition is satisfied; and/or

a PSSCH transmission between the first UE and the second UE failing, which further includes at least P2 consecutive transmission/reception failures, and/or detecting at least P2 transmission/reception failures within a time window having a length in a ninth threshold range. The transmission/reception failures include at least one of reception of NACK, transmission of NACK, non-reception of ACK feedback (the condition may correspond to a PSSCH using other HARQ-ACK feedback methods than NACK-only groupcast). P2 and/or the ninth threshold range may be preset and/or (pre) configured. The eighth and ninth threshold ranges may be the same and/or configured together, or may be different and/or configured separately.

Optionally, the second UE is triggered to transmit the at least one reference signal to the first UE, and/or to receive the first information transmitted by the first UE, and/or to transmit the signalling for requesting the first UE to transmit the first information and/or to indicate the at least one resource location for the first UE to transmit the first information, and/or to select at least one beam for communication with the first UE based on the first information transmitted by the first UE, when at least one of the following conditions is satisfied:
the second UE receiving, from the first UE, signaling for requesting the second UE to transmit a reference signal for measurement;
the second UE indicating, to the first UE, a set of resources for measuring and/or transmitting a reference signal, or indicating, to the first UE, a set of resources for measuring and/or transmitting the reference signal and transmitting the reference signal on the set of resources; optionally, the indicated set of resources is a set of resources transmitted to the first UE, e.g., a destination ID in SCI corresponding to the indication is an ID of the first UE;
the second UE being preset and/or (pre) configured with periodic resources, and/or the second UE acquiring at least one resource, which can be used to transmit the reference signal for measurement by other UEs, or is preset/configured/determined to be used to transmit the reference signal for measurement by other UEs;
the second UE being preset and/or (pre) configured with periodic transmission windows, and/or the first UE acquiring at least one transmission window, which may be indicated to the first UE by the second UE; the transmission window is used for the second UE to transmit the reference signal therein, which may be a reference signal for the first UE to measure;
the second UE transmitting at least K reference signals on resources in a certain time and/or frequency range, and/or acquiring resources that can be used to transmit the at least K reference signals; the time and/or frequency range may be preset and/or (pre) configured, and may correspond to a measurement window acquired by the first UE, and/or correspond to a transmission window acquired by the second UE;
at least one transmission window of the first UE having started, or starting after at least t1 time units, or starting after at most t2 time units, wherein the time units may be physical slots, or logical slots, or physical time units such as milliseconds; optionally, the condition is used to trigger the second UE to transmit at least one reference signal to the first UE;
at least one transmission window of the second UE ending; optionally, the condition is used to trigger the second UE to receive the first information transmitted by the first UE, and/or to transmit signaling for requesting the first UE to transmit the first information and/or to indicate at least one resource location for the first UE to transmit the first information, and/or to select at least one beam for communication with the first UE based on the first information transmitted by the first UE;
a measurement value of at least one beam of the first UE by the second UE being below the seventh threshold, and/or being below the seventh threshold at least P1 times consecutively, and/or being detected to be below the seventh threshold at least P1 times within a time window having a length in the eighth threshold range; and/or receiving a measurement value of at least one beam of the second UE by the first UE that is transmitted by the first UE and the measurement value being below the seventh threshold and/or being below the seventh threshold at least P1 times consecutively and/or being detected to be below the seventh threshold at least P1 times within a time window having a length in the eighth threshold range. P1 and/or the seventh threshold and/or the eighth threshold range may be preset and/or (pre) configured. The at least one beam may be a beam that has been used by the second UE to communicate with the first UE, or a corresponding beam thereof. For example, the beam used by the second UE to communicate with the first UE is transmission beam #5 of the second UE, which corresponds to reception beam #5 of the second UE, transmission beam #1 of the first UE, then when the measurement value of transmission beam #1 of the first UE by the second UE is below the seventh threshold, the condition is satisfied; and/or
a PSSCH transmission between the first UE and the second UE failing, which further includes at least P2 consecutive transmission/reception failures, and/or detecting at least P2 transmission/reception failures within a time window having a length in a ninth threshold range. The transmission/reception failures include at least one of reception of NACK, transmission of NACK, non-reception of ACK feedback (the condition may correspond to a PSSCH using other HARQ-ACK feedback methods than NACK-only groupcast). P2 and/or the ninth threshold range may be preset and/or (pre) configured. The eighth and ninth threshold ranges may be the same and/or configured together, or may be different and/or configured separately.

The at least one beam for communication with the first UE includes at least one transmission beam for communication with the first UE and/or at least one reception beam for communication with the first UE.

Optionally, for the condition in which the first UE is triggered to measure the reference signal from the second UE and/or to transmit the first information to the second UE, the condition in which the first UE is triggered to transmit to the second UE the signaling for requesting the second UE to transmit the reference signal for measurement, and the condition in which the second UE is triggered to transmit at least one reference signal to the first UE and/or to receive the first information transmitted by the first UE and/or to select at least one beam for communication with the first UE based on the first information transmitted by the first UE, the thresholds and times in the conditions may be the same and/or configured together, for example, the seventh thresholds in at least two types of conditions are the same; the thresholds and times may also be different and/or configured separately, for example, the seventh thresholds in the three types of conditions are configured by three different fields in RRC signaling.

Optionally, the second UE receives the first information transmitted by the first UE, and determines at least one beam for communication with the first UE based on the first information. The at least one beam for communication with the first UE includes at least one transmission beam for communication with the first UE and/or at least one reception beam for communication with the first UE.

Optionally, the second UE determines the at least one beam for communication with the first UE using at least one of the following first methods:
determining among preferred beams indicated in the first information;
determining based on whether measurement values corresponding to beams indicated in the first information exceed a tenth threshold, e.g., determining among beams exceeding the threshold, wherein the tenth threshold may be preset and/or (pre) configured, may be configured by configuration information of a higher layer/the first UE/the second UE/a resource pool, may be the same and/or configured together with the aforementioned various thresholds, or may be different and/or configured separately; and/or
determining based on whether there are beams that have been selected by the second UE for communication with other UEs and/or beams that have been indicated by the second UE to other UEs as preferred/selected beams among the beams indicated in the first information.

Optionally, the second UE determines the at least one beam for communication with the first UE using at least one of the following second methods:
determining according to whether the beams indicated in the first information have corresponding sensing results; further, for at least one beam indicated in the first information and the time resource set corresponding thereto, determining whether to use the beam as the at least one beam for communication with the first UE according to whether the second UE has a sensing result corresponding to the beam, and/or whether there are corresponding (sufficient number of) sensing results in a sensing window corresponding to transmission on at least one time resource on the time resource set; and/or
for the at least one beam indicated in the first information, determining whether to use the beam as the at least one beam for communication with the first UE according to whether there is a time resource in a time resource set corresponding to the at least one beam that can be used by the first UE to transmit a sidelink signal/channel to the second UE.

In a specific example, the second UE selects, as the beam for communication with the first UE, the beam indicated in the first information which is preferred and with a measurement value corresponding to the beam exceeding the tenth threshold, and has been selected by the second UE for communication with other UEs and/or has been indicated by the second UE to other UEs as preferred/selected beam, if the beam is present in the first information (if there are multiple beams, the beam may be randomly selected therein); otherwise, the beam indicated in the first information which is preferred and with a measurement value corresponding to the beam exceeding the tenth threshold is selected as the beam for communication with the first UE, if the beam is present in the first information (if there are multiple beams, the beam may be randomly selected therein); otherwise, the preferred beam indicated in the first information is selected (if there are multiple preferred beams, the beam may be randomly selected therein).

The first method may be used in combination with the second method. In another specific example, the second UE determines at least one candidate beam according to at least one of the above conditions (based on which the subsequent method is an example of combining the first method and the second method), and/or uses the beams indicated in the first information as the at least one candidate beam. The determining of at least one beam for communication with the first UE among the at least one candidate beam using the second method includes: if at least N1 time-frequency resources or at least N2 time resources in a time resource set corresponding to a candidate beam can be used for the second UE to transmit a PSSCH to the first UE, and the transmission on the at least N1 time-frequency resources or the at least N2 time resources is provided with (sufficient number of) sensing results in the corresponding sensing window, then the candidate beam may be used as a beam for communication with the first UE, and/or the at least N1 time-frequency resources or the at least N2 time resources may be used as resources for communication with the first UE.

Optionally, the UE further selects resources actually used for transmitting the PSSCH among the at least N1 time-frequency resources or at least N2 time resources, and/or continues to select beams actually used for transmitting the PSSCH and/or other sidelink signals/channels among multiple candidate beams that can be used as beams for communication with the first UE when the multiple candidate beams are present, e.g., according to sensing selection or random selection. N1 and N2 are integers greater than or equal to 1, at least one of the values of N1 and N2, the maximum value of N1 and N2, the minimum value of N1 and N2, which is preset and/or (pre) configured, may be configured by configuration information of a higher layer/the first UE/the second UE/a resource pool, and N1 and N2 may be the same and/or configured together, or may be different and/or configured separately.

Optionally, the second UE determines at least one beam for communication with the first UE and indicates the determined beam to the first UE. Further including indicating with at least one of:
indicating in the SCI the beam used by the at least one PSSCH associated with the SCI; and/or
indicating in the MAC CE the beams used by all sidelink signals/channels within a given time range; optionally, when the beam used by the sidelink signal/channel is additionally indicated, the beam used by the sidelink signal/channel is the additionally indicated beam instead of the beam indicated in the MAC CE. The start position of the given time range may be determined according to the time point at which the MAC CE is located, e.g., the time point plus a first time offset. The end position of a given time range may be determined from the time point at which the MAC CE is located or the time point of the start position of the time range, e.g., the time point plus a second time offset; or the end position of the given time range is a time point when the MAC CE indicating the beam is received next time, or the time point plus the first time offset; or the end position of a given time range is infinite, i.e. always valid. The first and/or second time offset may be preset and/or (pre) configured.

The indicated beam may be indicated by at least one of a TCI status, QCL information, a beam index.

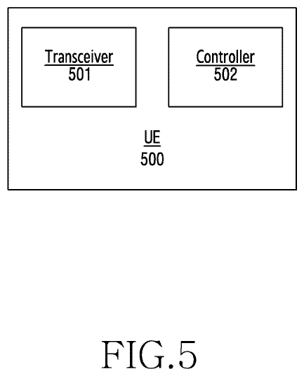

FIG. 5 illustrates a user equipment (UE) 500 according to various embodiments of the present disclosure.

Referring to FIG. 5, a UE 500 according to various embodiments of the present disclosure may include a transceiver 501 and a controller 502. For example, the transceiver 501 may be configured to transmit and receive signals. For example, the controller 502 may be coupled to the transceiver 501 and configured to perform the aforementioned methods.

Those skilled in the art will understand that the above illustrative embodiments are described herein and are not intended to be limiting. It should be understood that any two or more of the embodiments disclosed herein may be combined in any combination. Furthermore, other embodiments may be utilized and other changes may be made without departing from the spirit and scope of the subject matter presented herein. It will be readily understood that aspects of the present disclosure as generally described herein and shown in the drawings may be arranged, replaced, combined, separated and designed in various different configurations, all of which are contemplated herein.

Those skilled in the art will understand that the various illustrative logical blocks, modules, circuits, and steps described in this application may be implemented as hardware, software, or a combination of both. To clearly illustrate this interchangeability between hardware and software, various illustrative components, blocks, modules, circuits, and steps are generally described above in the form of their functional sets. Whether such function sets are implemented as hardware or software depends on the specific application and the design constraints imposed on the overall system. Technicians may implement the described functional sets in different ways for each specific application, but such design decisions should not be interpreted as causing a departure from the scope of this application.

The various illustrative logic blocks, modules, and circuits described in this application may be implemented or performed by a general purpose processor, a digital signal processor (DSP), an application specific integrated circuit (ASIC), a field programmable gate array (FPGA) or other programmable logic devices, discrete gates or transistor logics, discrete hardware components, or any combination thereof designed to perform the functions described herein. The general purpose processor may be a microprocessor, but in an alternative, the processor may be any conventional processor, controller, microcontroller, or state machine. The processor may also be implemented as a combination of computing devices, such as a combination of a DSP and a microprocessor, more than one microprocessors, one or more microprocessors cooperating with a DSP core, or any other such configuration.

The steps of the method or algorithm described in this application may be embodied directly in hardware, in a software module executed by a processor, or in a combination thereof. The software module may reside in RAM memory, flash memory, ROM memory, EPROM memory, EEPROM memory, register, hard disk, removable disk, or any other form of storage medium known in the art. An exemplary storage medium is coupled to a processor to enable the processor to read and write information from/to the storage media. In an alternative, the storage medium may be integrated into the processor. The processor and the storage medium may reside in an ASIC. The ASIC may reside in a user terminal. In an alternative, the processor and the storage medium may reside in the user terminal as discrete components.

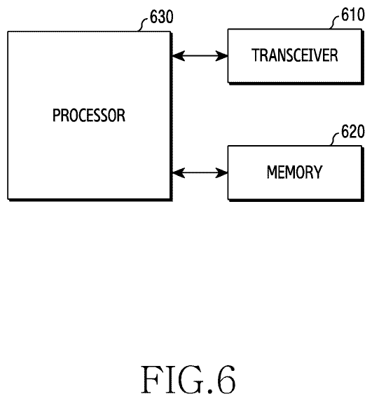

FIG. 6 illustrates a terminal (or a user equipment (UE)) according to various embodiments of the present disclosure. FIG. 6 corresponds to the example of the UE of FIG. 3a.

As shown in FIG. 6, the UE according to an embodiment may include a transceiver 610, a memory 620, and a processor 630. The transceiver 610, the memory 620, and the processor 630 of the UE may operate according to a communication method of the UE described above. However, the components of the UE are not limited thereto. For example, the UE may include more or fewer components than those described above. In addition, the processor 630, the transceiver 610, and the memory 620 may be implemented as a single chip. Also, the processor 630 may include at least one processor.

The transceiver 610 collectively refers to a UE receiver and a UE transmitter, and may transmit/receive a signal to/from a base station or a network entity. The signal transmitted or received to or from the base station or a network entity may include control information and data. The transceiver 610 may include a RF transmitter for up-converting and amplifying a frequency of a transmitted signal, and a RF receiver for amplifying low-noise and down-converting a frequency of a received signal. However, this is only an example of the transceiver 610 and components of the transceiver 610 are not limited to the RF transmitter and the RF receiver.

Also, the transceiver 610 may receive and output, to the processor 630, a signal through a wireless channel, and transmit a signal output from the processor 630 through the wireless channel.

The memory 620 may store a program and data required for operations of the UE. Also, the memory 620 may store control information or data included in a signal obtained by the UE. The memory 620 may be a storage medium, such as read-only memory (ROM), random access memory (RAM), a hard disk, a CD-ROM, and a DVD, or a combination of storage media.

The processor 630 may control a series of processes such that the UE operates as described above. For example, the transceiver 610 may receive a data signal including a control signal transmitted by the base station or the network entity, and the processor 630 may determine a result of receiving the control signal and the data signal transmitted by the base station or the network entity.

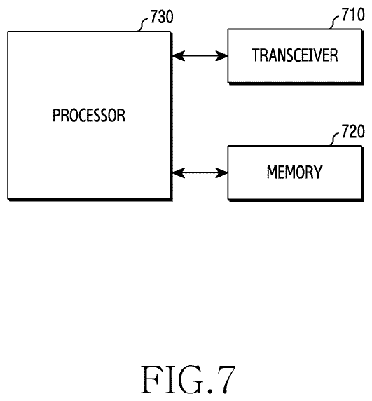

FIG. 7 illustrates a base station according to various embodiments of the present disclosure. FIG. 7 corresponds to the example of the gNB of FIG. 3b.

As shown in FIG. 7, the base station according to an embodiment may include a transceiver 710, a memory 720, and a processor 730. The transceiver 710, the memory 720, and the processor 730 of the base station may operate according to a communication method of the base station described above. However, the components of the base station are not limited thereto. For example, the base station may include more or fewer components than those described above. In addition, the processor 730, the transceiver 710, and the memory 720 may be implemented as a single chip. Also, the processor 730 may include at least one processor.

The transceiver 710 collectively refers to a base station receiver and a base station transmitter, and may transmit/receive a signal to/from a terminal or a network entity. The signal transmitted or received to or from the terminal or a network entity may include control information and data. The transceiver 710 may include a RF transmitter for up-converting and amplifying a frequency of a transmitted signal, and a RF receiver for amplifying low-noise and down-converting a frequency of a received signal. However, this is only an example of the transceiver 710 and components of the transceiver 710 are not limited to the RF transmitter and the RF receiver.

Also, the transceiver 710 may receive and output, to the processor 730, a signal through a wireless channel, and transmit a signal output from the processor 730 through the wireless channel.

The memory 720 may store a program and data required for operations of the base station. Also, the memory 720 may store control information or data included in a signal obtained by the base station. The memory 720 may be a storage medium, such as read-only memory (ROM), random access memory (RAM), a hard disk, a CD-ROM, and a DVD, or a combination of storage media.

The processor 730 may control a series of processes such that the base station operates as described above. For example, the transceiver 710 may receive a data signal including a control signal transmitted by the terminal, and the processor 730 may determine a result of receiving the control signal and the data signal transmitted by the terminal.

In one or more exemplary designs, the functions may be implemented in hardware, software, firmware, or any combination thereof. If implemented in software, each function may be stored as one or more pieces of instructions or codes on a computer-readable medium or delivered through it. The computer-readable medium includes both a computer storage medium and a communication medium, the latter including any medium that facilitates the transfer of computer programs from one place to another. The storage medium may be any available medium that can be accessed by a general purpose or special purpose computer.

The above description is only an exemplary implementation of the present disclosure, and is not intended to limit the scope of protection of the present disclosure, which is determined by the appended claims.

In the afore-described embodiments of the present disclosure, elements included in the present disclosure are expressed in a singular or plural form according to the embodiments. However, the singular or plural form is appropriately selected for convenience of explanation and the present disclosure is not limited thereto. As such, an element expressed in a plural form may also be configured as a single element, and an element expressed in a singular form may also be configured as plural elements.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope. The scope of patented subject matter is defined by the claims.

Although the present disclosure has been described with various embodiments, various changes and modifications may be suggested to one skilled in the art. It is intended that the present disclosure encompass such changes and modifications as fall within the scope of the appended claims.

What is claimed is:

1. A method performed by a first user equipment (UE) in a wireless communication system, the method comprising:
receiving, from a second UE, at least one reference signal;
measuring the at least one reference signal; and
transmitting, to the second UE, first information including at least one of at least one preferred beam or at least one time resource set,
wherein the at least one time resource set is associated with at least one first beam.

2. The method of claim 1, wherein the at least one reference signal is transmitted on at least one second beam, and wherein measuring the at least one reference signal comprises measuring the at least one second beam.

3. The method of claim 1, wherein the first information further includes at least one of:
measurement information related to the at least one reference signal;
second information indicating at least one third beam selected, by the first UE, from at least one second beam and comprises at least one beam for a sidelink transmission between the first UE and the second UE; or
third information indicating at least one fourth beam including at least one of the at least one preferred beam or the at least one third beam.

4. The method of claim 1, wherein the first UE indicates the at least one preferred beam in the first information by at least one of:
including a set of beams in the first information, the set of beams including preferred beams;
including N beam measurement information in the first information, at least one or each of the N beam measurement information includes at least one of information indicating a beam or information indicating whether the beam is preferred beam, and N being an integer value greater than or equal to 1;
including, in the first information, the N beam measurement information and the information indicating whether the N beam measurement information is for preferred beam; or
including, in the first information, information related to preferred beam and no information related to other beams according to at least one of a preset or preconfigured criterion.

5. The method of claim 3, wherein the first information indicates that the at least one preferred beam is based on at least one of:
the first UE being at least one of preset or preconfigured to indicate at least one of a preferred beam or the preferred beam and a non-preferred beam;
the first UE being at least one preset or preconfigured to preferentially indicate the preferred beam; or
a procedure performed by the first UE being one of an initial beam acquisition, a beam maintenance, or a beam failure recovery.

6. The method of claim 3, further comprising at least one of:
determining whether at least one fifth beam of the first UE or at least one second beam of the second UE is used as at least one of the at least one preferred beam or the at least one third beam; or
determining whether the at least one fifth beam or the at least one third beam is indicated by the first information, wherein the at least one fifth beam is at least one beam for a sidelink transmission between the first UE and the second UE that is determined based on a result of a measurement operation.

7. The method of claim 6, further comprising at least one of:
determining that M beams with best results of the measurement operation are indicated by the first information, wherein M is an integer value greater than or equal to 1;
determining that the M beams with the best results of the measurement operation are used as the at least one preferred beam, the at least one third beam, or at least one fourth beam, or the at least one fifth beam, or the M beams are indicated by the first information;
determining that M beams with results of the measurement operation exceeding a first threshold are indicated by the first information;
determining that M beams with the results of the measurement operation exceeding a second threshold are used as the at least one preferred beam, the at least one third beam, the at least one fourth beam, or the at least one fifth beam, or the M beams are indicated by the first information;
determining that N beams with worst results of the measurement operation are indicated by the first information;
determining that the N beams with the worst results of the measurement operation are used as non-preferred beams and indicated by the first information, wherein N is an integer value greater than or equal to 0;
determining that the N beams with results of the measurement operation below a third threshold are indicated by the first information;
determining that the N beams with the results of the measurement operation below a fourth threshold, or exceeding a fifth threshold and below the fourth threshold are indicated by the first information as non-preferred beams; or
determining that beams selected for a communication with other UEs or beams indicated as preferred beams or selected beams to other UEs are used as the at least one preferred beam or indicated by the first information.

8. The method of claim 1, wherein the first information indicates the at least one time resource set by indicating at least one of:
a time-domain position of each time resource in the at least one time resource set;
information of a periodic time resource or a periodic time window; or
at least one information of a time window including at least one of:
a start position of the time window, an end position of the time window, a length of the time window, an offset between the start position or the end position of the time window, and a time point at which the first information is transmitted; or
information related to a discontinuous reception (DRX) timer.

9. The method of claim 3, wherein the first information indicating the at least one time resource set comprises at least one beam corresponding to the at least one time resource set through the third information.

10. The method of claim 9, wherein indicating the at least one beam corresponding to the at least one time resource set through the third information comprises at least one of:
indicating a beam associated with each time resource set of the at least one time resource set when one beam corresponds to one time resource set or indicating a beam associated with multiple time resource sets of the at least one time resource set when one beam corresponds to the multiple time resource sets; or
indicating a beam corresponding to the at least one time resource set or a beam corresponding to each time resource set of the at least one time resource set based on a preset criterion, by an explicit indication, or by an implicit indication.

11. A method performed by a second user equipment (UE) in a wireless communication system, the method comprising:
transmitting, to a first UE, at least one reference signal; and
receiving, from the first UE, first information including at least one of at least one preferred beam or at least one time resource set,
wherein the at least one time resource set is associated with at least one first beam.

12. The method of claim 11, wherein the at least one reference signal is transmitted on at least one second beam, and wherein measuring the at least one reference signal comprises measuring the at least one second beam.

13. The method of claim 11, wherein the first information further includes at least one of:
measurement information related to the at least one reference signal;
second information indicating at least one third beam selected, by the first UE, from at least one second beam and comprises at least one beam for a sidelink transmission between the first UE and the second UE; or
third information indicating at least one fourth beam including at least one of the at least one preferred beam or the at least one third beam.

14. The method of claim 11, further comprising at least one of:
transmitting, to the first UE, signaling for requesting the first UE to transmit the first information;
indicating, to the first UE, at least one resource location for the first UE to transmit the first information; or
determining at least one sixth beam for a sidelink transmission with the first UE based on the first information.

15. The method of claim 14, wherein determining the at least one sixth beam for communicating with the first UE based on the first information comprises at least one of:
determining the at least one sixth beam among the at least one preferred beam;
determining the at least one sixth beam based on whether a measurement value of the at least one reference signal exceeds a tenth threshold;
determining the at least one sixth beam based on whether there is a beam that has been selected by the second UE for communicating with other UEs, the beam that has been indicated by the second UE to other UEs as preferred beam, or selected beam among beams indicated by the first information;
determining the at least one sixth beam according to whether the beams indicated by the first information have corresponding sensing results; or
determining whether to use the beams indicated by the first information as the at least one sixth beam according to whether there is a time resource available for the first UE to transmit a sidelink signal or channel to the second UE in a time resource set corresponding to the beams.

16. A first user equipment (UE) in a wireless communication system, the first UE comprising:
a transceiver, and
a controller coupled with the transceiver and configured to:
receive, from a second UE, at least one reference signal,
measure the at least one reference signal, and
transmit, to the second UE, first information including at least one of at least one preferred beam or at least one time resource set,
wherein the at least one time resource set is associated with at least one first beam.

17. The first UE of claim 16, wherein the at least one reference signal is transmitted on at least one second beam, and wherein measuring the at least one reference signal comprises measuring the at least one second beam.

18. The first UE of claim 16, wherein the first information further includes at least one of:
measurement information related to the at least one reference signal;
second information indicating at least one third beam selected, by the first UE, from at least one second beam and comprises at least one beam for a sidelink transmission between the first UE and the second UE; or
third information indicating at least one fourth beam including at least one of the at least one preferred beam or the at least one third beam.

19. The first UE of claim 16, wherein the first UE indicates the at least one preferred beam in the first information by at least one of:
including a set of beams in the first information, the set of beams including preferred beams;
including N beam measurement information in the first information, at least one or each of the N beam measurement information includes at least one of information indicating a beam or information indicating whether the beam is preferred beam, and N being an integer value greater than or equal to 1;
including, in the first information, the N beam measurement information and the information indicating whether the N beam measurement information is for preferred beam; or
including, in the first information, information related to preferred beam and no information related to other beams according to at least one of a preset or preconfigured criterion.

20. A second user equipment (UE) in a wireless communication system, the second UE comprising:
a transceiver, and
a controller coupled with the transceiver and configured to:
transmit, to a first UE, at least one reference signal, and
receive, from the first UE, first information including at least one of at least one preferred beam or at least one time resource set,
wherein the at least one time resource set is associated with at least one first beam.
